(19) United States
(12) Patent Application Publication
(10) Pub. No.: US 2025/0139353 A1
(43) Pub. Date: May 1, 2025

(54) IDENTIFYING IMAGE BASED CONTENT ITEMS USING A LARGE LANGUAGE MODEL

(71) Applicant: Pinterest, Inc., San Francisco, CA (US)

(72) Inventors: Jesus Armando Ordorica de la Torre, Toronto (CA); Alice Jenlin Chang, San Mateo, CA (US); Dong Hyun Lee, Walnut Creek, CA (US); Darren Peter Reger, Auburn, CA (US); David Yun, Woodland Hills, CA (US); Jessica Chen, Milipitas, CA (US)

(21) Appl. No.: 18/499,984

(22) Filed: Nov. 1, 2023

(51) Int. Cl. G06F 40/169; G06F 40/40

(52) U.S. Cl. CPC G06F 40/169; G06F 40/40

(57) ABSTRACT

Disclosed are systems and methods that process a selection of a plurality of content items through a Large Language Model (“LLM”) and determine, based on that processing, other content items to present or recommend. For example, one or more non-text content item may be processed to generate one or more captions descriptive of the non-text content item(s). The captions may then be processed by a LLM to determine a narrative description of the content items and the narrative description may be used as a text-based query to determine recommended content items.

### BACKGROUND

Search systems and recommender systems are both online services that recommend content to a computer user (or, more simply, a “user”) in response to a query. Search systems respond to a query with a focused set of results that are viewed as “answers” to a query. In contrast, recommender systems are not necessarily tasked with responding with “answers,” i.e., content that is specifically relating to the query. Instead, recommender systems respond to queries with recommended content, i.e., content calculated to lead a requesting user to discovering new content. Roughly, search systems provide a focused scope to a specific topic while recommender systems provide a broadened scope. For both types of systems, however, it is quite common for the requesting user to submit a text-based query and, in response, expect non-text content items.

There are online hosting services whose primary focus is to maintain non-textual content items for its users/subscribers. These content items are maintained as a corpus of content items and often become quite large. Indeed, at least one existing hosting service maintains a corpus that includes over a billion content items that have been posted to the hosting service by its users/subscribers. However, determining the content items from the billions of content items that should be presented or recommended to a user is often difficult.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary networked environment suitable for implementing aspects of the disclosed subject matter.

FIGS. 2A and 2B are a transition diagram illustrating the determination and presentation of a sequence of recommended content items, in accordance with aspects of the disclosed subject matter.

FIGS. 3A and 3B are a transition diagram illustrating the determination and presentation of a plurality of recommended content items, in accordance with aspects of the disclosed subject matter.

FIG. 4 is a block diagram of system components that may be utilized to determine a sequence of recommended content items, in accordance with aspects of the disclosed subject matter.

FIG. 5 is an example recommended content items and sequence process, in accordance with aspects of the disclosed subject matter.

FIG. 6 is a block diagram illustrating the generation of a sequence of recommended content items, in accordance with aspects of the disclosed subject matter.

FIG. 7 is a block diagram of system components that may be utilized to determine a plurality of recommended content items, in accordance with aspects of the disclosed subject matter.

FIG. 8 is an example recommended content item(s) process, in accordance with aspects of the disclosed subject matter.

FIG. 9 is an example session caption process, in accordance with aspects of the disclosed subject matter.

FIG. 10 is a block diagram illustrating the generation of a plurality of recommended content items, in accordance with aspects of the disclosed subject matter.

FIG. 11 is a block diagram of a Large Language Model input, generated in accordance with aspects of the disclosed subject matter.

FIG. 12 is a block diagram of an example Large Language Model output that may be generated in accordance with aspects of the disclosed subject matter.

FIG. 13 is an illustration of a presentation of a plurality of recommended content items, in accordance with aspects of the disclosed subject matter.

FIG. 14 is a pictorial diagram illustrating the mapping of text embedding vectors into a text content embedding space and the mapping of image embedding vectors into an image content embedding space, in accordance with aspects of the disclosed subject matter.

FIG. 15 is a pictorial diagram illustrating the mapping of both text embedding vectors and image embedding vectors into a single embedding space, in accordance with aspects of the disclosed subject matter.

FIG. 16 is a flow diagram illustrating an exemplary process for returning one or more content items to a subscriber in response to a text-based request, in accordance with aspects of the disclosed subject matter.

FIG. 17 is a block diagram illustrating an exemplary content item graph of content items from a corpus of content items, configured according to aspects of the disclosed subject matter.

FIG. 18 is a flow diagram illustrating an exemplary process for determining a set of content items for a representative embedding vector, in accordance with aspects of the disclosed subject matter.

FIG. 19 is a flow diagram illustrating an exemplary process for training a machine learning model to generate embedding vectors into a content item embedding space for a text-based request, in accordance with aspects of the disclosed subject matter.

FIGS. 20A and 20B demonstrate flow diagrams illustrating various exemplary processes for generating training data for training a machine learning model to generate an embedding vector into a content item space for a text-based request, in accordance with aspects of the disclosed subject matter.

FIG. 21 is a flow diagram illustrating an exemplary, generalized process for training a machine learning model to generate content item embedding vectors for text-based requests, in accordance with aspects of the disclosed subject matter.

FIG. 22 is a block diagram illustrating an exemplary computer-readable medium encoded with instructions for responding to a subscriber's request for content items from a corpus of content items, formed in accordance with aspects of the disclosed subject matter.

FIG. 23 is a block diagram of a computing system suitably configured to implement aspects of a hosting service, including responding to a subscriber's request for content items from a corpus of content items, in accordance with aspects of the disclosed subject matter.

### DETAILED DESCRIPTION

Disclosed are systems and methods that determine recommended non-text content items (e.g., images) based on one or more selected or provided content items, referred to herein as session content items. As discussed further below, the disclosed implementations may generate a content item caption for each session content item and/or generate a session caption that is descriptive of the group of session content items. The caption(s) may then be processed by a Large Language Model (“LLM”) which will generate and output an LLM output that includes a narrative description of the session content items. The narrative description may then be used as a text-based request into a query service that identifies and returns one or more recommended content items. Alternatively, the LLM may provide, as an LLM output, a list of content item identifiers that the LLM selects from a set of provided LLM content item identifiers that may also have corresponding captions, as recommended content items that are responsive to the session content items. The recommended content items may then be provided for presentation to a user, utilized to generate a category, vertical, etc.

As discussed further below, in some implementations, the query service, in response to a text-based request, may process the text-based request into a set of word pieces from terms of the received request. In some implementations, at least one term of the received request results in at least two word pieces. Embedding vectors that project source content (in this case word pieces) into a content item embedding space are generated for each word piece of the set of word pieces for the received request, and the embedding vectors are combined into a representative embedding vector for the request. A set of content items of a corpus of content items are identified according to the representative embedding vector as projected into the content item embedding space. At least some of the content items from the set of content items are returned as content items in response to the request from the subscriber.

By way of definition and as those skilled in the art will appreciate, an “embedding vector” is an array of values that reflect aspects and features of source/input content. For example, an embedding vector of an image will include an array of values describing aspects and features of that image. An executable model or process, referred to as an embedding vector generator, generates an embedding vector for input content. Indeed, the embedding vector generator generates the same learned features to identify and extract information of each instance of input content. This processing leads to the generation of an embedding vector for an instance of input content. As those skilled in the art will appreciate, embedding vectors generated by the same embedding vector generator based on the expected input content are comparable, such that a greater similarity between two embedding vectors indicates a greater similarity between the source items—at least as determined by the embedding vector generator. By way of illustration and not limitation, an embedding vector may comprise 128 elements, each element represented by a 32- or 64-bit floating point value, each value representative of some aspect (or multiple aspects) of the input content. In other implementations, the embedding vector may have additional or fewer elements and each element may have additional or fewer floating-point values, integer values, and/or binary values.

As those skilled in the art will appreciate, embedding vectors are comparable across the same element within the embedding vectors. For example, a first element of a first embedding vector can be compared to a first element of a second embedding vector generated by the same embedding vector generator on distinct input items. This type of comparison is typically viewed as a determination of similarity for that particular element between the two embedding vectors. On the other hand, the first element of a first embedding vector cannot typically be compared to the second element of a second embedding vector because the embedding vector generator generates the values of the different elements based on distinct and usually unique aspects and features of input items.

Regarding embedding vector generators, typically an embedding vector generator accepts input content (e.g., an image, video, or multi-item content), processes the input content through various levels of convolution, and produces an array of values that specifically reflect on the input data, i.e., an embedding vector. Due to the nature of a trained embedding vector generator (i.e., the convolutions that include transformations, aggregations, subtractions, extrapolations, normalizations, etc.), the contents or values of the resulting embedding vectors are often meaningless to personal examination. However, collectively, the elements of an embedding vector can be used to project or map the corresponding input content into an embedding space as defined by the embedding vectors.

As indicated above, two embedding vectors (generated from the same content type by the same embedding vector generator) may be compared for similarity as projected within the corresponding embedding space. The closer that two embedding vectors are located within the embedding space, the more similar the input content from which the embedding vectors were generated.

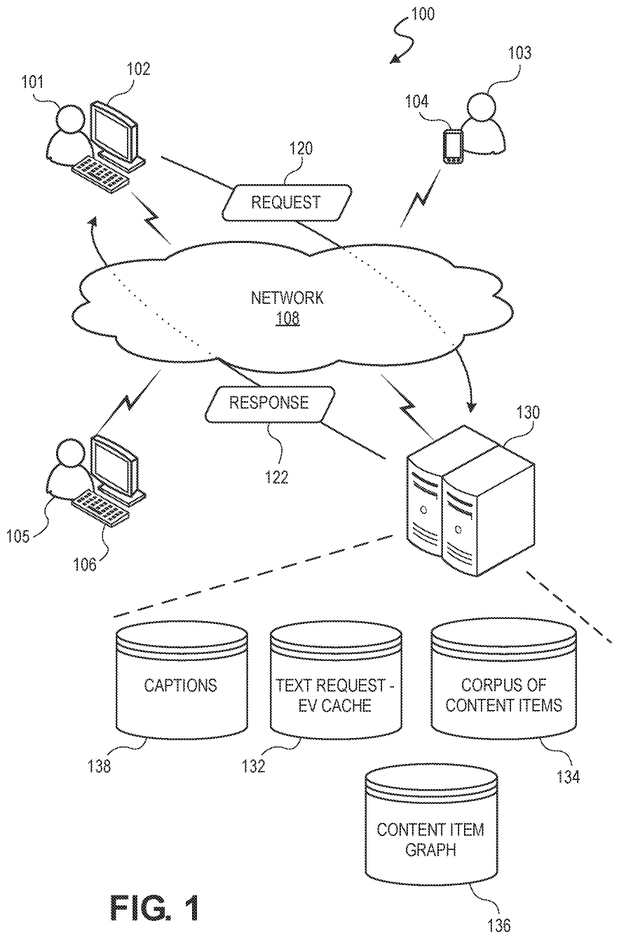

FIG. 1 is a block diagram illustrating an exemplary networked environment 100 suitable for implementing aspects of the disclosed subject matter, particularly in regard to providing a response 122 of one or more content items to a subscriber of a hosting service 130 to a request 120.

The network 108 is a computer network, also commonly referred to as a data network. As those skilled in the art will appreciate, the computer network 108 is fundamentally a telecommunication network over which computers, computing devices such as computing devices 102, 104 and 106, and other network-enabled devices and/or services can electronically communicate, including exchanging information and data among the computers, devices and services. In computer networks, networked computing devices are viewed as nodes of the network. Thus, in the exemplary networked environment 100, computing devices 102, 104 and 106, as well as the hosting service 130, are nodes of the network 108.

In communicating with other devices and/or services over the network 108, connections between other devices and/or services are conducted using either cable media (e.g., physical connections that may include electrical and/or optical communication lines), wireless media (e.g., wireless connections such as 802.11x, Bluetooth, and/or infrared connections), or some combination of both. While a well-known computer network is the Internet, the disclosed subject matter is not limited to the Internet. Indeed, elements of the disclosed subject matter may be suitably and satisfactorily implemented on wide area networks, local area networks, enterprise networks, and the like.

As illustrated in the exemplary network environment 100 of FIG. 1, a subscriber, such as computer user 101, of a hosting service 130 submits a request 120 to the hosting service in anticipation of the hosting service returning one or more content items as a response 122 to the request. According to aspects of the disclosed subject matter, the hosting service 130 processes the received request 120 and identifies one or more content items from a corpus 134 of content items to identify the content items of the response 122 that is returned to the subscriber.

As indicated above, a hosting service 130 is an online service that, among other things, maintains a corpus 134 of content items. The content items of this corpus are typically obtained from one or more subscribers and/or other providers (e.g., businesses) through a posting service of the hosting service (also called a hosting system), a recommender service that provides recommended content (content items) to a subscriber, and/or a search service that responds to a request for related/relevant content items to a request. Indeed, the hosting service 130 is a network-accessible service that typically provides application programming interfaces (APIs), processes and functions to its users/subscribers, including those described herein.

According to aspects of the disclosed subject matter, computer users, such as computer users 101, 103 and 105, may be subscribers of the various services of the hosting service 130, i.e., making use of one or more features/functions/services of the hosting service. Indeed, according to aspects of the disclosed subject matter, a subscriber is a computer user that takes advantage of services available for an online service, such as hosting service 130. In the exemplary network environment 100 of FIG. 1, computer user 101 is a subscriber of the hosting service 130.

In accordance with aspects of the disclosed subject matter, a subscriber requesting content from the hosting service 130, such as computer user 101, submits a request 120 to the hosting service. The request may be a text-based request, such as a text-based search query, a selection of multiple content items from the corpus 134 that are submitted as the request, one or more content items uploaded or provided by the user to the hosting service as the request, etc. The request may be an explicit request, such as a text-based search request or a specific search request in which one or more content items are selected or provided by a user. In other examples, the request may be implicit. For example, as a user browses content items of the hosting service, the hosting service may maintain identifiers of the browsed content items and utilize those content items as the basis for a request. As another example, if a user selected to view or close-up a content item from the corpus, that content item may be utilized as a request to determine other content items that are similar to the viewed content item. Still further, the disclosed implementations may be utilized to determine content items without an explicit or implicit request from a user. For example, the disclosed implementations may be used to determine content items that are like one or more other content items (e.g., have a similar style, fashion, etc.). Accordingly, it will be appreciated that the disclosed implementations are operable with any type or text-based request or content item-based request regardless of whether it is a request from a user (explicit or implicit) or otherwise.

In response to a request 120 for content, the hosting service 130, draws from the corpus 134 of content items, identifying one or more content items that satisfy the request. As will be set forth in greater detail below and according to aspects of the disclosed subject matter, if the request is a text-based request, a set of word pieces is generated for the terms of the request 120. If the request includes one or more content items, those content item(s) may be processed, as discussed further herein, to generate a caption for the content item(s) (either individually or collectively) and that caption(s) may then be processed to a text-based request from which word pieces are generated for the request. Embedding vectors for the word pieces are determined and combined to form a representative embedding vector for the request. Using the representative embedding vector, content items from the corpus are identified.

Alternatively, or in addition thereto, rather than determining word pieces for content items of a request 120, the content item(s) of the request and at least some of the content items from the corpus 134, referred to herein as a reduced corpus, may be processed to determine captions of those content items and those captions further processed, for example by a Large Language Model (“LLM”), to determine content items from the reduced corpus that correspond to the content item(s) of the request. After identifying the content items, the hosting service 130 returns the one or more content items to the requesting subscriber as a response 122 to the request 120 and/or handles them in accordance with the intent of the request—e.g., creates a taste preference guide.

As shown in FIG. 1, the hosting service 130 includes a data store storing a corpus 134 of content items, a data store that stores a text request-embedding vector cache 132 that stores a cache of text queries with corresponding embedding vectors, and a data store that stores information of a content item graph 136 of the content items of the corpus of content items, each of which may be used in identifying content items as a response 122 to a request from the subscriber/computer user 101. In some implementations, the hosting service 130 may also include a data store that stores captions 138 for each content item of the corpus 134 of content items, as may be determined in accordance with the disclosed implementations. Of course, this particular arrangement of the hosting service 130 is a logical configuration, not necessarily an actual configuration. Indeed, there may be multiple data stores that collectively store the corpus 134 of content items, the word pieces-embedding vector cache 132, the content item graph 136, and/or captions 138. Additionally, and/or alternatively, these data items may be hosted on one or more computing devices accessible to the hosting service 130 via the network 108. Accordingly, the illustrated networked environment's 100 arrangement of computers and computing devices including computers and computing devices 102, 104 and 106, and hosting service 130 with its data store data sources should be viewed as illustrative and not limiting.

As discussed herein, one or more services, whether internal to the hosting service or external and accessed by the hosting service, may process one or more content items to determine captions for each of the one or more content items and/or determine a caption for a plurality of content items. For example, an image encoder and language model, such as BLIP-2, FLAMINGO80B, VQAv2, etc., may be used to generate captions for each of a plurality of content items and/or a group of content items (or the captions for each content item combined to form a single caption for a plurality of content items). A caption, as used herein, is a short descriptive or explanatory text, usually one or two sentences long, that describes or explains a content item or a plurality of content items.

Likewise, as discussed further herein, a caption for a content item for each of a plurality of content items, or a caption for a group of content items, may be processed by an LLM to determine descriptors and/or a text request for the content item or plurality of content items of the request. Alternatively, in some implementations, an LLM input may be generated that includes both captions for one or more content items of a request, captions for one or more content items of a reduced corpus, and instructions that the LLM determine one or more content items as recommended content items based on the captions of the one or more content items of the request.

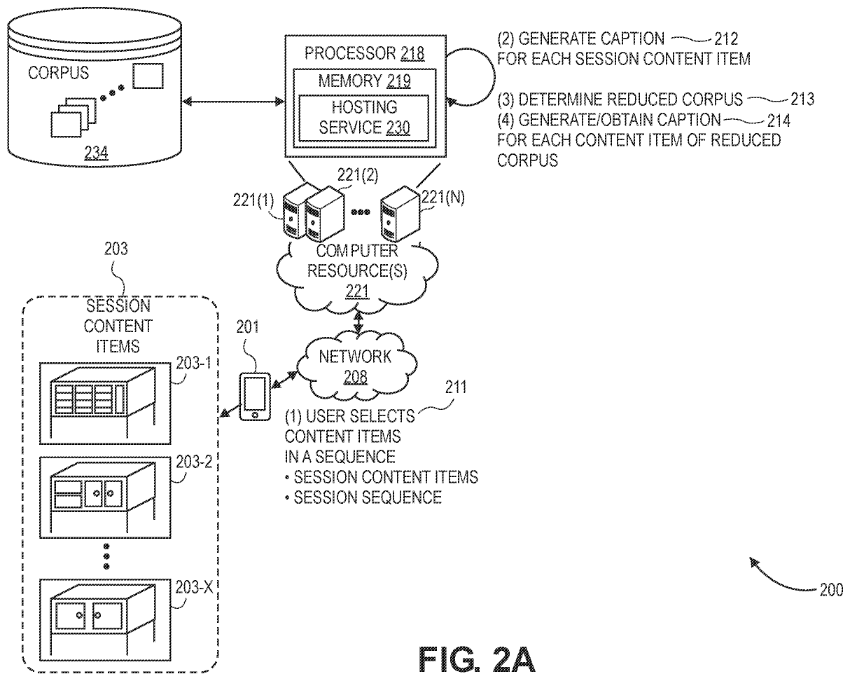

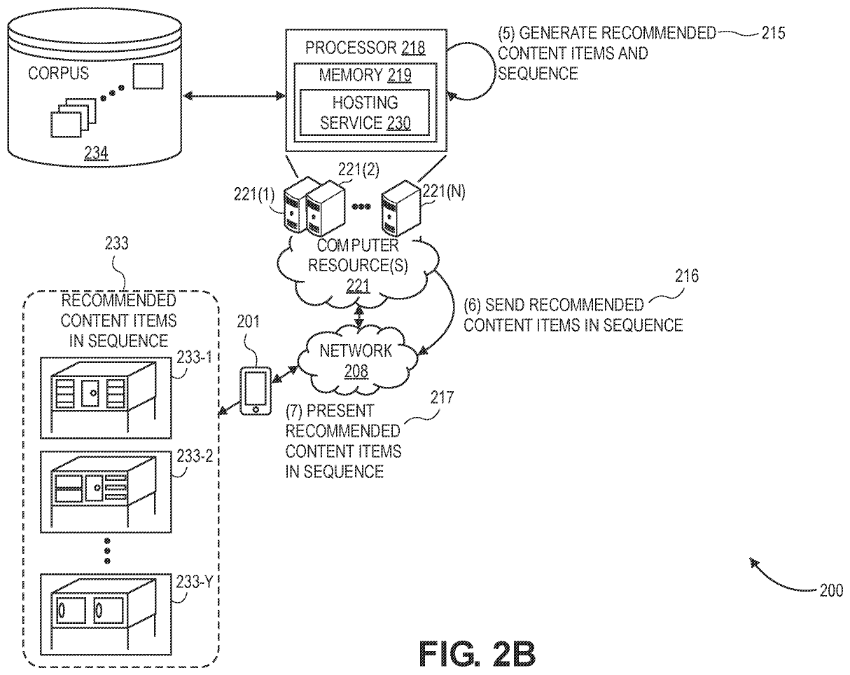

FIGS. 2A and 2B are a transition diagram 200 illustrating the determination and presentation of a sequence of recommended content items, in accordance with aspects of the disclosed subject matter.

In the illustrated example, a user, during a session and through interaction with a device 201, selects or views a plurality of content items 203-1, 203-2, through 203-X, as in 211. The selection of content items during the session constitutes the session content items 203. Any number of content items may be selected during a session and included as session content items 203. In this example, the user is selecting different content items that are images of sideboards. As the content items are selected, the sequence in which each content item is selected may also be maintained or determined. As discussed above, the session content items may be selected from a corpus 234 of content items that is accessible by the device 201 through the hosting service 230. In other examples, some or all of the content items of the session content items may be selected from or provided by the device 201. For example, during the session the user may take an image of a sideboard and that image may be provided to the hosting service 230 as a content item of the sequence of content items included in the session content items 203.

During or after the session, some or all of the session content items 203 are sent, via the network 208, from the device 201 to the hosting service 230. For example, after the user has viewed five content items, those content items, or content item identifiers corresponding to those content items may be sent to the hosting service 230. In other implementations, content item identifiers may be sent or streamed to the hosting service as the content items are viewed or selected by the user as part of the session.

The hosting service 230, upon receiving identification of content items viewed by the user, may process the content items to generate captions descriptive of each content item, as in 212. For example, the hosting service 230 may include and/or access an image encoder and language model, such as BLIP-2, FLAMINGO80B, VQAv2, etc. and/or internally maintained services, referred to herein generally as a “caption service,” and provide each content item to the caption service and receive a caption descriptive of the content item. Each caption may be associated with a content item identifier of the corresponding content item. For example, the hosting service 230 may maintain a content item identifier for each content item, which may be unique for each content item. In some examples, captions may be pre-determined for content items 203 and maintained in a caption corpus 234 accessible to the hosting service. In such an example, the hosting service 230 may obtain the caption for each content item of the session content items from the caption data store rather than having to re-process each content item to determine a caption. Likewise, if some of the content items do not have a corresponding caption in the caption data store, those content items may be processed with a caption service to determine a caption for the content item and the caption, with the corresponding content item identifier, may be added to the caption data store.

In addition to determining a caption for each content item of the session content items 203, the hosting service 230 may also determine, based at least in part on the session content items, a reduced corpus that includes less than all of the content items of the corpus 234 of content items, as in 213. For example, the corpus 234 of content items may be reduced to the reduced corpus by excluding content items of the session content items 203 viewed by the user. In still further implementations, the corpus may be further reduced based on existing relationships between content items of the session content items 203 and content items of the corpus, to exclude content items that are in different categories or verticals than those of the session content items, etc. In other examples, the corpus may not be reduced.

The hosting service may then generate or obtain a caption for each content item of the reduced corpus, as in 214. For example, the content items of the reduced corpus may be processed by the same or similar caption service used to process the session content items. In other examples, captions may be pre-determined and stored in a caption data store for each content item of the reduced corpus. In such an example, rather than re-process each content item of the corpus, the hosting service may obtain the caption from the caption data store. In such an example, as new content items are added to the corpus, the content item may be processed with a caption service to determine a caption for the content item and the caption, with the corresponding content item identifier, may be added to the caption data store.

The system may also include computing resource(s) 221. The computing resource(s) 221 may be remote from the user device 201. Likewise, the computing resource(s) 221 may be configured to communicate over a network 208 with the user device 201.

As illustrated, the computing resource(s) 221 may be implemented as one or more servers 221(1), 221(2), . . . , 221(N) and may, in some instances, form a portion of a network-accessible computing platform implemented as a computing infrastructure of processors, storage, software, data access, and so forth that is maintained and accessible by components/devices of the system via a network 208, such as an intranet (e.g., local area network), the Internet, etc. The computing resources 221 may process content items, captions, etc., to generate recommended content items, as discussed herein.

The server system(s) 221 does not require end-user knowledge of the physical location and configuration of the system that delivers the services. Common expressions associated for these remote computing resource(s) 221 include “on-demand computing,” “software as a service (SaaS),” “platform computing,” “network-accessible platform,” “cloud services,” “data centers,” and so forth. Each of the servers 221(1)-(N) include a processor 218 and memory 219, which may store or otherwise have access to a hosting service 230, as described herein.

The network 208, and each of the other networks discussed herein, may utilize wired technologies (e.g., wires, USB, fiber optic cable, etc.), wireless technologies (e.g., radio frequency, infrared, NFC, cellular, satellite, Bluetooth, etc.), or other connection technologies. The network 208 is representative of any type of communication network, including data and/or voice network, and may be implemented using wired infrastructure (e.g., cable, CAT6, fiberoptic cable, etc.), a wireless infrastructure (e.g., RF, cellular, microwave, satellite, Bluetooth, etc.), and/or other connection technologies.

Turning now to FIG. 2B, using the caption for each of the session content items and the captions for the content items of the reduced corpus, a recommended set of one or more content items and a sequence for those content items may be generated, as in 215. As discussed further below, in some implementations, an LLM input may be defined that includes instructions that the LLM consider the caption and sequence of each content item of the session content items and select a set and sequence of content items from the reduced corpus of content items that should be presented next to the user in the sequence of content items. The instructions may further specify the minimum and/or maximum number of content items that are to be recommended.

Based on the LLM input, the LLM will process each caption of the sequence of content items of the session content items and compare those captions with captions of each content item of the reduced corpus of content items to determine content items from the reduced corpus that are most closely related to the content items of the session of content items. The LLM may also determine, based on the sequence of the content items of the session of content items, the captions of the content items of the session of content items, and the captions of the content items selected from the reduced corpus of content items, a sequence in which the selected content items are to be presented.

The recommended content items 233-1, 233-2 through 233-Y, determined by the hosting service and the sequence on which those items are to be presented are then sent, via the network 208, to the device 201, as in 216. The device 201, upon receiving the recommended content items and the sequence of presentation of those recommended content items, presents the recommended content items 233 in the specified sequence, as in 217. In some implementations, a merchant(s) that offers an item(s) represented in at least one of the recommended content items 233 for sale may also be determined and indicated as part of the presentation of the recommended content items 233.

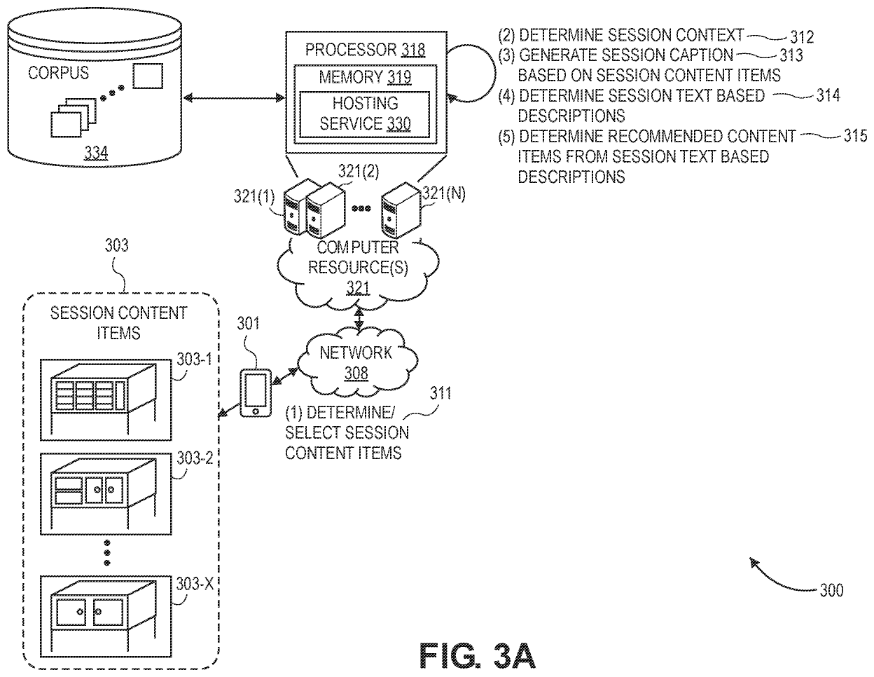

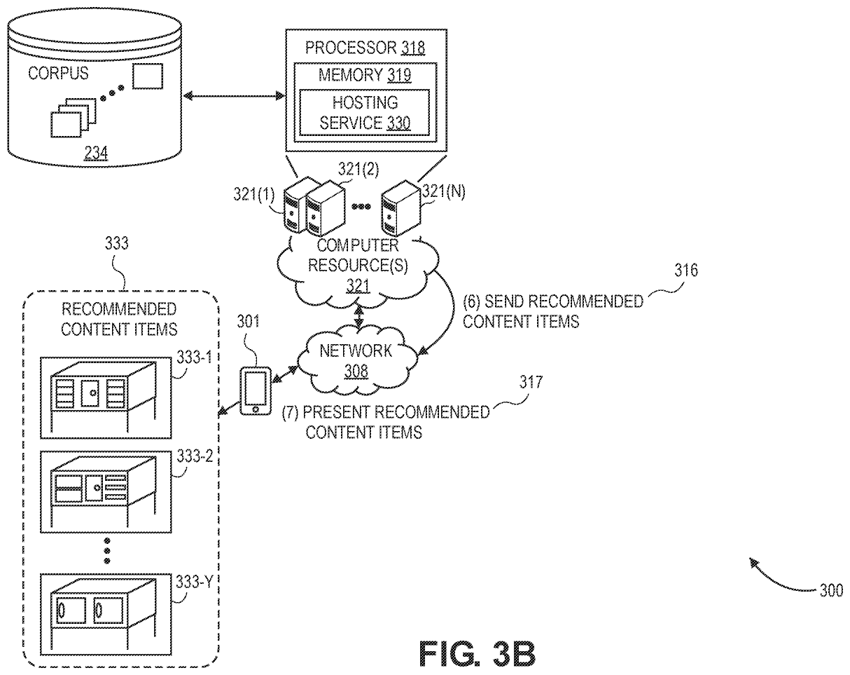

FIGS. 3A and 3B are a transition diagram 300 illustrating the determination and presentation of a plurality of recommended content items, in accordance with aspects of the disclosed subject matter.

In the illustrated example, a user, during a session and through interaction with a device 301, selects or views a plurality of content items 303-1, 303-2, through 303-X, as in 311. The selection of content items during the session constitutes the session content items 303. Any number of content items may be selected during a session and included as session content items 303. In this example, the user is selecting different content items that are images of sideboards. As discussed above, the session content items may be selected from a corpus 334 of content items that is accessible by the device 301 through the hosting service 330. In other examples, some or all of the content items of the session content items may be selected from or provided by the device 301. For example, during the session the user may take an image of a sideboard and that image may be provided to the hosting service 330 as a content item included in the session content items 303.

During or after the session, some or all of the session content items 303 are sent, via the network 308, from the device 301 to the hosting service 330. For example, after the user has viewed five content items, those content items, or identifiers corresponding to those content items may be sent to the hosting service 330. In other implementations, content item identifiers may be sent or streamed to the hosting service as they are viewed or selected by the user as part of the session.

The hosting service 330, upon receiving identification of content items viewed by the user, in some implementations, may determine a session context for the session, as in 312. For example, if the session content items are included in a named group or list of content items, the name of the group may be determined to be the context. In other examples, metadata (e.g., annotations, keywords, etc.) associated with the content items may be processed to determine a relationship between the content items and used as the session context. For example, annotations or keywords associated with the session content items may include words such as furniture, home decor, bedroom, etc. In such an example, one or more of the keywords/annotations found most often associated with the session content items may be determined and used as the session context. In other examples, if the content items are viewed from a particular section or vertical of content items, such as a vertical for “home decor” that is maintained and presented to the user by the hosting service, the vertical may be determined and used as the session context. In still other examples, the session context may not be determined or may be omitted.

In addition to optionally determining a session context for the session, the hosting service 330 may also process the session content items 303 to generate captions descriptive of each content item, as in 313. For example, the hosting service 330 may include and/or access one or more internal and/or external caption services and provide the session content items to the caption service(s) and receive a caption descriptive of the session. In some implementations, the caption service may process all of the content items collectively and generate a single session caption descriptive of the session content items. In other examples, each content item of the session content items may be processed by the caption service(s) and a content item caption determined for each content. Those content item captions may then be combined to generate a session caption for the session. In instances when multiple caption services are used, each caption service may generate a caption for the session content items, referred to herein as a service caption, and those service captions may be combined to generate a session caption for the session.

Using the session context and the session caption, a text-based description may be generated that is descriptive of the session content items, as in 314. As discussed further below, in some implementations, an LLM input may be defined that includes instructions that the LLM consider the session context and the session caption to generate a session text-based description that is descriptive of the session content items, when considering the session context. Based on the LLM input, the LLM will process the session caption, considering the session context, and generate a text-based description of the session.

The text-based description may then be used as a text input to a query system of the hosting service (discussed further below) to determine recommended content items to return to the device 301 for presentation, as in 315.

The system may also include computing resource(s) 321. The computing resource(s) 321 may be remote from the user device 301. Likewise, the computing resource(s) 321 may be configured to communicate over a network 308 with the user device 301.

As illustrated, the computing resource(s) 321 may be implemented as one or more servers 321(1), 321(2), . . . , 321(N) and may, in some instances, form a portion of a network-accessible computing platform implemented as a computing infrastructure of processors, storage, software, data access, and so forth that is maintained and accessible by components/devices of the system via a network 308, such as an intranet (e.g., local area network), the Internet, etc. The computing resources 321 may process content items, captions, etc., to generate recommended content items, as discussed herein.

The server system(s) 321 does not require end-user knowledge of the physical location and configuration of the system that delivers the services. Common expressions associated for these remote computing resource(s) 321 include “on-demand computing,” “software as a service (SaaS),” “platform computing,” “network-accessible platform,” “cloud services,” “data centers,” and so forth. Each of the servers 321(1)-(N) include a processor 318 and memory 319, which may store or otherwise have access to a hosting service 330, as described herein.

The network 308, and each of the other networks discussed herein, may utilize wired technologies (e.g., wires, USB, fiber optic cable, etc.), wireless technologies (e.g., radio frequency, infrared, NFC, cellular, satellite, Bluetooth, etc.), or other connection technologies. The network 308 is representative of any type of communication network, including data and/or voice network, and may be implemented using wired infrastructure (e.g., cable, CAT6, fiberoptic cable, etc.), a wireless infrastructure (e.g., RF, cellular, microwave, satellite, Bluetooth, etc.), and/or other connection technologies.

Turning now to FIG. 3B, the hosting service 330 may then send, via the network 308, the recommended content items 333-1, 333-2, through 333-Y, as in 316, and the device 301, upon receiving the recommended content items, may present the recommended content items 333, as in 317. In some implementations, the hosting service 330 may also determine a merchant(s) that offers an item(s) or object represented in at least one of the recommended content items 233 for sale. In such an implementation, the merchant may also be identified in the presentation so that the object represented in the one or more content items may be purchased through the merchant.

As noted above, regardless of the implementation used, the content items included in the session content items discussed with respect to FIGS. 2A/2B and/or FIGS. 3A/3B may be explicitly selected by a user, implicitly selected by a user, or selected from another source that is independent of the user, such as for creation of a category or vertical. In implementations in which the user is not providing the session content items, rather than the recommended content items being provided to the user device for presentation, the recommended content items may be provided back to the hosting service and/or other entity for use as intended—e.g., creation of a taste preference guide, vertical, category, etc.

While the example discussed with respect to FIGS. 2A/2B, and as will be discussed elsewhere herein includes a sequence of the session content items and recommending a sequence for the recommended content items, in other implementations, sequencing may be omitted and recommended content items may be determined from the session content items independent of any sequence. Likewise, while the example discussed with respect to FIGS. 3A/3B do not utilize or determine a sequence for either the session content items and/or the recommended content items, in other implementations, the sequence of the session content items and/or the recommended content items may be determined as part of the implementations discussed herein.

Still further, in some implementations, as discussed further below, user preferences, user location, content item locations (i.e., the location of a physical item represented by a content item) may also be determined and considered as part of the disclosed implementations when determining recommended content items. For example, referring back to FIG. 3A, in addition to utilizing the text-based descriptors determined from the session content items to determine the recommended content items, the location of the user, the session context, and/or the location of physical items corresponding to content items of the corpus may also be considered in determining the recommended content items. For example, if the session content items relate to an article of clothing (e.g., blouse) and the user is physically located in a shopping district that has a blouse shop and content items included in the corpus of content items correspond to blouses available for purchase from that blouse shop, the disclosed implementations may consider that information and possibly provide one or more content items corresponding to a physical blouse available for purchase from that blouse shop. In such an example, when presented to the user, the recommended content item(s) may also include an indication that the blouse represented in the content item(s) is available for purchase from the blouse shop that is physically near the user, and may include directions or instructions for navigating to the blouse shop from the current location of the user.

As another example, the disclosed implementations may also consider known user preferences, styles, etc., that have been previously determined and/or provided by the user when determining recommended content items.

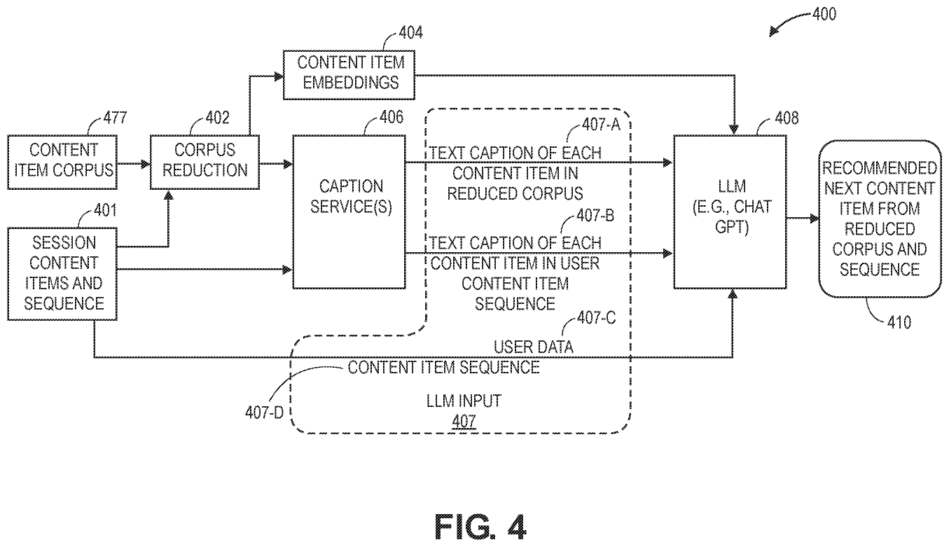

FIG. 4 is a block diagram 400 of system components that may be utilized to determine a sequence of recommended content items, in accordance with aspects of the disclosed subject matter. The block diagram 400 corresponds with the examples discussed above with respect to FIGS. 2A/2B, 4, 5, and 6.

The system components discussed with respect to FIG. 4 may be entirely included in the hosting service. In other implementations, some of the system components, such as the caption service 406 and/or the LLM 408 may be separate from, but accessible to the hosting service.

As discussed above, and elsewhere herein, session content items 401 and a sequence in which the session content items were viewed or selected by a user is received by the hosting service and processed by one or more caption services 406 and a corpus reduction component 402. For example, the caption service(s) 406 may process each content item of the session content items to generate a content item caption for each content item 407-B. In implementations in which multiple caption services are utilized, the service caption generated by each caption service for a content item may be combined to generate the content item caption for the content item.

Likewise, the corpus reduction component 402 may utilize the session content items 401 and/or other user information to generate a reduced corpus. For example, the corpus reduction component 402 may also process the corpus to remove any duplicates, to remove any content items that the user has previously viewed, or previously viewed within a defined period of time, remove items that are not relevant to the session—for example based on metadata associated with the content items and/or the session content items, etc.

Content items of the reduced corpus may also be provided to the caption service(s) and, like the session content items, a caption may be generated for each content item of the reduced corpus 407-A. For example, the caption service(s) 406 may process each content item of the reduced corpus of content items to generate a content item caption for each content item. In implementations in which multiple caption services are utilized, the service caption generated by each caption service for a content item of the reduced content item corpus may be combined to generate the content item caption for that content item.

The hosting service may then generate an LLM input 407 based on the content item caption of each content item of the session content items 407-B, the content item caption of each content item of the reduced corpus 407-A, user data 407-C, and the content item sequence 407-D. For example, the hosting service may generate an LLM input 407 that includes or references the content item caption for each session content item 407-B, that includes or references the content item caption for each content item of the reduced corpus 407-A, and that includes instructions that the LLM is to consider the content item caption of each session content item 407-B in the sequence provided and to select one or more content items as recommended content items based on the caption of each content item from the reduced content item corpus 407-A. The instructions may further provide a minimum and maximum number of content items that are to be returned as recommended content items, instructions to indicate a sequence in which the recommended content items are to be presented, an LLM output structure that is to be provided by the LLM, etc. Still further, the LLM input 407 may also provide additional context or parameters to guide the LLM in selection of recommended content items. For example, additional context or parameters may be specified based on user data 407-C such as indicating preferred styles, colors, shapes, etc., known about the user that are to be considered in conjunction with the caption of each session content item in determining recommended content items.

The LLM 408, upon receiving the LLM input generated by the hosting service processes the content item captions of the session content items, the content item captions of the content items of the reduced content item corpus, the sequence, instructions, etc., and determines one or more recommended content items from the reduced content item corpus, along with a sequence in which those content items are to be presented 410.

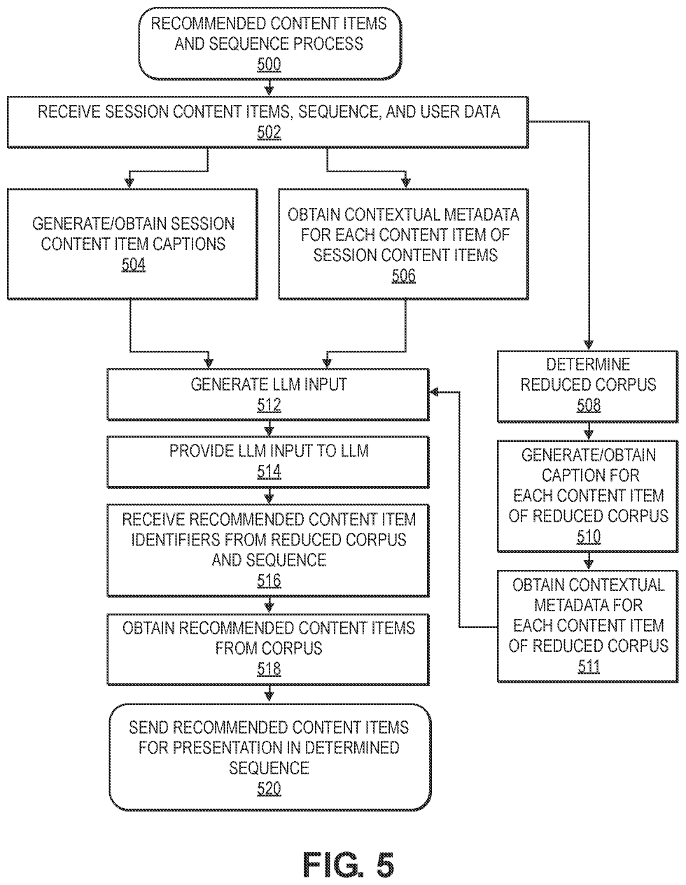

FIG. 5 is an example recommended content items and sequence process 500, in accordance with aspects of the disclosed subject matter. The example process 500 corresponds to the implementations discussed with respect to FIGS. 2A/2B, 4, and 6.

The example process 500 begins upon receipt of session content items, a sequence in which those session content items were viewed or selected by a user, and user data about a user, as in 502. As discussed above, a user may select or view one or more content items during a session or interaction between a user device and the hosting service. Content items viewed during the session are provided or identified to the hosting service as session content items. In some examples, the user device or an application executing on the user device may send indications of content items to the hosting service as those content items are viewed or selected by the user. Likewise, if the user interacts with one or more of the viewed content items, any such interaction may also be provided to the hosting service.

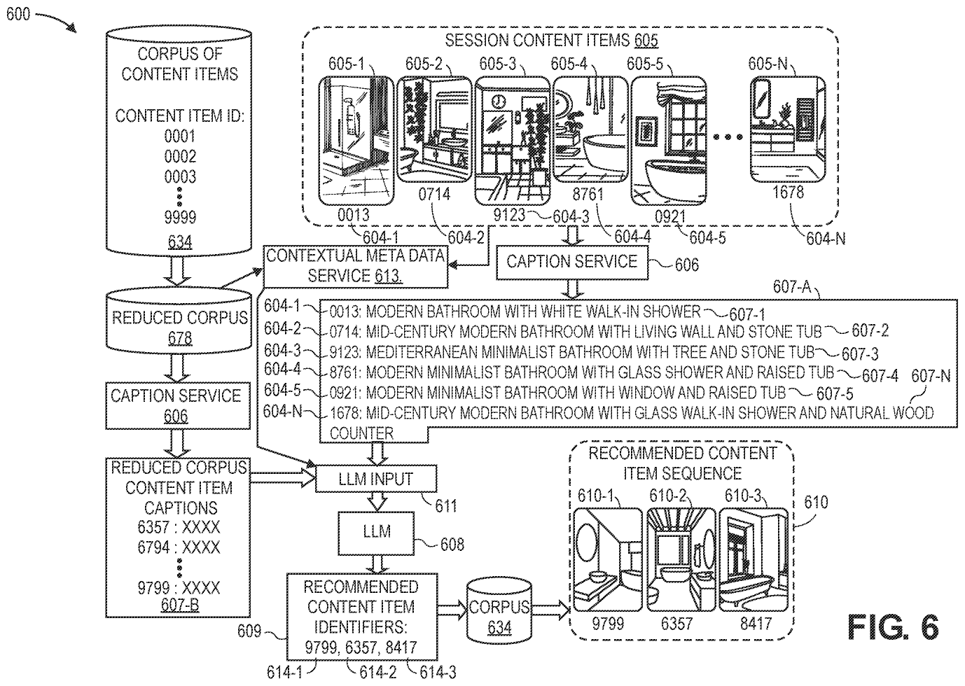

The session content items may then each be processed, for example by one or more caption services, to generate a content item caption descriptive of the session content item, as in 504. The content item caption, once generated, may be associated with a content item identifier for the content item. For example and referring briefly to FIG. 6, which is a block diagram 600 illustrating the generation of a sequence of recommended content items, in accordance with aspects of the disclosed subject matter, each content item 605-1, 605-2, 605-3, 605-4, 605-5, through 605-N of the session content items 605 may be processed by a caption service 606 and captions 607-1, 607-2, 607-3, 607-4, 607-5, through 607-N may be generated and associated with the content item identifier 604-1, 604-2, 604-3, 604-4, 605-5, through 604-N of the respective content item to produce a list of session content item captions 607-A. In the illustrated example, the content item 605-1 is processed by the caption service 606 and the content item caption “modern bathroom with white walk-in shower” is generated and associated with the content item identifier 604-1. The content item 605-2 is processed by the caption service 606 and the content item caption “Mid-Century modern bathroom with living wall and stone tub” is generated and associated with the content item identifier 604-2. The content item 605-3 is processed by the caption service 606 and the content item caption “Mediterranean style minimalist bathroom with tree and stone tub” is generated and associated with the content item identifier 604-3. The content item 605-4 is processed by the caption service 606 and the content item caption “modern minimalist bathroom with glass shower and raised tub” is generated and associated with the content item identifier 604-4. The content item 605-5 is processed by the caption service 606 and the content item caption “modern minimalist bathroom with window and raised tub” is generated and associated with the content item identifier 604-5. Caption generation may be performed for each content item of the session content items 605 up through content item 605-N, which, in this example, is processed by the caption service 606 and the content item caption “Mid-Century modern bathroom with glass walk-in shower and natural wood counter” is generated and associated with the content item identifier 604-N.

Returning to FIG. 5, in addition to generating captions for each content item of the session content items, in some implementations, contextual metadata, such as tokenized word embeddings, for each content item of the session content items may also be obtained, as in 506. For example, a contextual metadata service 613 (FIG. 6) may obtain, for each session content items, keywords describing the content item, annotations associated with the content item, descriptions of the content item, popularity information for the content item, trending information for the content item, etc.

The example process 500 may also utilize the session content items and/or contextual metadata determined for the session content items to determine a reduced corpus of content items, as in 508. For example, and returning again to FIG. 6, in some implementations, the corpus of content items 634 may be processed to remove some of the content items to produce a reduced corpus 678. For example, the content items of the session content items 605 may be removed to produce the reduced corpus 678 of content items. Alternatively, or in addition thereto, information known about the session, user data known about the user, information known about the content items, contextual information determined for session content items, and/or other information may be used to reduce the corpus of content items 634 to produce the reduced corpus 678 of content items. For example, content items that are unrelated to the session and/or the session content items 605 may be removed as part of producing the reduced corpus 678. In other examples, content items of the corpus 634 that have been recently viewed by the user or are known to not be preferred by the user may be removed as part of producing the reduced corpus 678 of content items.

The reduced corpus of content items may then be processed to generate a content item caption for each content item of the reduced corpus, as in 510. For example, the caption service 606, which may be the same or different caption service that generated captions for the session content items, may process each content item of the reduced corpus 678 to generate a list of reduced corpus content item captions 607-B. Like the session content item captions, the caption generated for each content item of the reduced corpus 678 may be associated with the content item identifier and included in the reduced corpus content item captions 607-B. Likewise, the contextual metadata service 613 may also determine, for each content item of the reduced corpus of content items, contextual metadata.

Returning to FIG. 5, upon generation of the list of reduced corpus content item captions, the list of session content item captions, and contextual metadata for the reduced corpus content items and session content items, the example process 500 may generate an LLM input, as in 512. For example, the LLM input 611 (FIG. 6) may be created to include or reference the list of session content item captions 607-A, the list of reduced corpus content item captions 607-B, the contextual metadata corresponding to each session content items 605, the contextual metadata corresponding to each reduced corpus content item 678, the sequence in which the session content items were viewed, instructions as to how the LLM is to process the content items, etc. For example, the instructions may instruct the LLM to consider each session content item caption from the list of session content item captions 607-A, the corresponding contextual information for those session content items, and the sequence provided for those session content items and to select one or more reduced corpus content item captions from the list of reduced corpus content item captions 607-B that should be viewed next in the sequence following the session content items described by the sequence of session content item captions included in the list of session content item captions 607-A. The instructions may further provide a minimum and maximum number of reduced corpus content item captions that are to be returned as recommended content items, instructions to indicate a sequence in which the recommended content items are to be presented, etc. Still further, the instructions may instruct the LLM to only return the content item identifier that is selected from the list of reduced corpus content item identifiers that correspond to the recommended content item(s). In some implementations, the LLM input 611 may also be defined to include additional context or parameters to guide the LLM in selection of recommended content items. For example, additional context or parameters may be specified based on user data, such as indicating preferred styles, colors, shapes, etc., known about the user that are to be considered in conjunction with each session content item caption and each reduced corpus content item identifier in determining recommended content item identifiers from the list of reduced corpus content item captions.

The example process 500 may then provide the LLM input to an LLM, such as GPT-4, BERT, Galactica, LaMDA, Llama, or an LLM defined and trained by the hosting service, as in 514. The LLM, upon receipt of the LLM input, processes the list of session content item captions and the list of reduced corpus content item captions, in accordance with the instructions, and outputs a sequenced list of recommended content item identifiers that are received by the example process, as in 516 and as illustrated as recommended content item identifiers 609 (FIG. 6). In the example illustrated in FIG. 6, the LLM 608 returns content item identifiers 614-1, 614-2, and 614-3, that uniquely identify content items from the reduced corpus 678 of content items and likewise included in the corpus 634.

The example process 500 may then obtain the recommended content items from the corpus, or the reduced corpus, that are identified by the recommended content item identifiers that are returned by the LLM, as in 518. Finally, the obtained recommended content items may be sent, in accordance with the determined sequence, for presentation, as in 520. Returning again to FIG. 6, the recommended content item identifiers 609 may be used to query the corpus 634 and return the recommended content items 610-1, 610-2, 610-3 corresponding to the recommended content item identifiers 614-1, 614-2, 614-3 that are then sent, in sequence, for presentation 610 as a sequence of recommended content items.

In some implementations, the example process 500 may also determine a merchant(s) that offers an item(s) or object represented in at least one of the recommended content items for sale. In such an implementation, the merchant may also be identified in the presentation so that the object represented in the one or more content items may be purchased through the merchant.

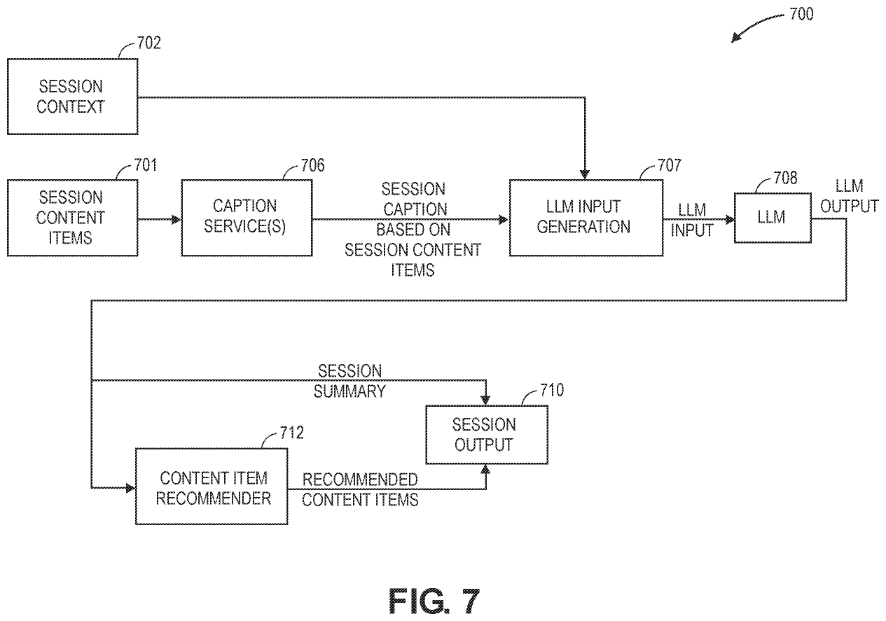

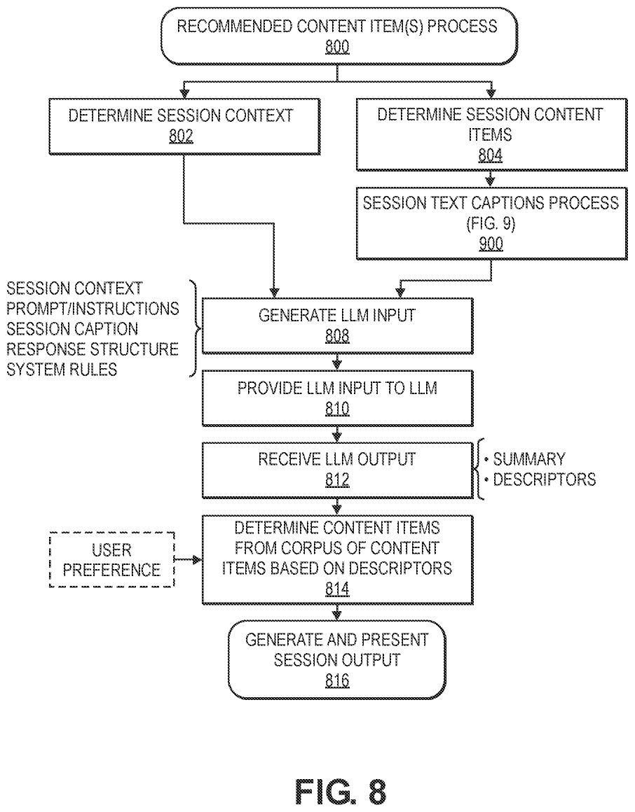

FIG. 7 is a block diagram 700 of system components that may be utilized to determine a plurality of recommended content items, in accordance with aspects of the disclosed subject matter. The block diagram 700 corresponds with the examples discussed above with respect to FIGS. 3A/3B, and FIGS. 8-13.

The system components discussed with respect to FIG. 7 may be entirely included in the hosting service. In other implementations, some of the system components, such as the caption service(s) 706 and/or the LLM 708 may be separate from, but accessible to the hosting service.

As discussed above, and elsewhere herein, session content items 701 viewed or selected by a user, or otherwise provided to the system, are received by the hosting service and processed by one or more caption service(s) 706. For example, the caption service(s) 706 may process each content item of the session content items to generate a caption for each content item and those content item captions may be combined to generate a single session caption for the session content items 701. Alternatively, the caption service(s) 706 may process all the session content items 701 together and generate a session caption descriptive of the session content items. Likewise, as discussed further below, in examples in which multiple caption services 706 are used, each caption service may generate a service caption for the session content items, as determined by that caption service, and each of the service captions may then be combined to generate the session caption for the session content items 701.

Likewise, a session context 702 may be received and/or determined for the session. The session context may be provided as part of the session content items, may be determined based on the content items, may be determined based on user browser history, user preferences, metadata about or relating to the session content items, etc.

The hosting service may then generate an LLM input 707 based on the caption of each session content item, the session context, and the desired output to be received from the LLM 708. For example, the hosting service may generate an LLM input 707 that includes or references the session caption for the session content items 701, that includes the session context 702, and that includes instructions that the LLM is to consider the session caption, the session context, and output a session description representative of the session content items 701 collectively. The instructions may specify a specific structure for the LLM output, a request for a summary of the session content items be provided, that the LLM pick from a set of summary descriptors as a summary for the session content item, etc. Still further, the LLM input 707 may also provide additional context, parameters, and/or other instructions to guide the LLM in generation of the LLM output and session description. For example, additional context or parameters may be specified based on user data, such as indicating preferred styles, colors, shapes, etc., known about the user that are to be considered in conjunction with the session caption in determining recommended content items.

The LLM 708, upon receiving the LLM input generated by the hosting service processes the session caption, the session context, etc., in accordance with the instructions of the LLM input, and generates an LLM output that includes the session description and, optionally, a session summary.

The session description may then be provided as a text-based request to a content item recommender 712 and determine one or more content items from a corpus of content items to select as recommended content items. As discussed further below, the content item processes the text-based request and returns one or recommended content items. The example process 700 may then combine the recommended content items, the session summary, and optionally other information as session output 710.

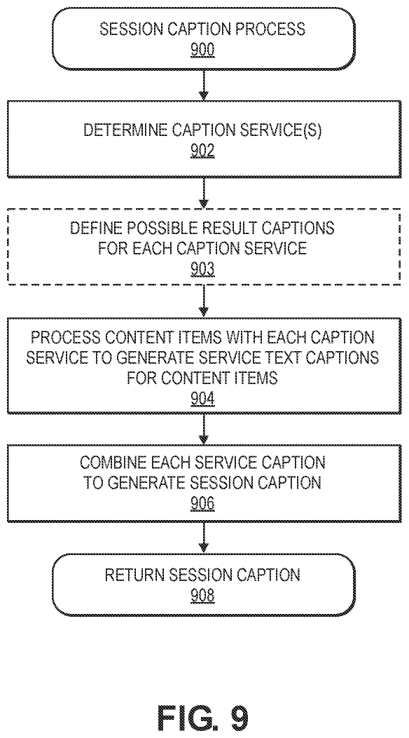

FIG. 8 is an example recommended content items process 800, in accordance with aspects of the disclosed subject matter. The block diagram 800 corresponds with the examples discussed above with respect to FIGS. 3A/3B, 7, and FIGS. 9-13.

The example process 800 begins upon receipt of, or by determining session content items, as in 804. As discussed above, a user may select or view one or more content items during a session or interaction between a user device and the hosting service. Content items viewed during the session are provided or identified to the hosting service as session content items. In some examples, the user device or an application executing on the user device may send indications of content items to the hosting service as those content items are viewed or selected by the user. Likewise, if the user interacts with one or more of the viewed content items, any such interaction may also be provided to the hosting service. In other examples, the session content items may be selected by the hosting service or another entity for use in creating a feed, vertical, category, etc.

In addition to determining or receiving the content items, a session context may be received or determined, as in 802. For example, the session context may be a feed, vertical, category, etc., from or for which the session content items were selected. Alternatively, the content items may be initially processed (e.g., image processing, querying annotations, etc.) to determine the session context and/or the contextual metadata corresponding to the content items may be processed to determine a session context.

The session content items may then be processed to generate a session caption descriptive of the session content items, as in 900. The session caption process 900 is discussed further below with respect to FIG. 9, and elsewhere herein.

Utilizing the session context and the session caption, the example process 800 generates an LLM input, as in 808.

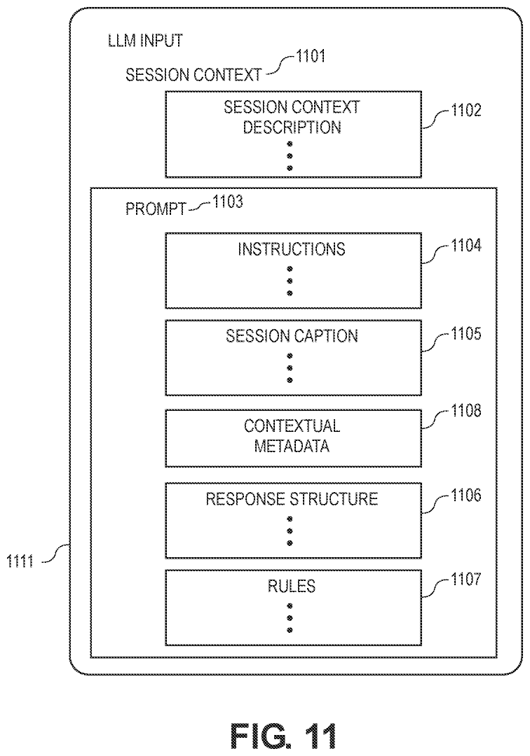

For example and referring briefly to FIG. 11, the LLM input 1111 may include the session context 1101, which may include one or more session context descriptors 1102 that the LLM may choose from as a summary of the session. For example, if the example process is being used to select content items to represent a bathroom ideas taste preference guide, the list of descriptors that are provided to the LLM may include, as an example, “modern,” “mediterranean.” “country,” “coastal,” “mediterranean: spanish,” “mediterranean: italian,” “mid-century modern,” “moroccan,” and “traditional.” In other examples, other descriptors may be provided. In still other examples, the LLM may not be given a list of descriptors and the LLM input may include instructions that the LLM is to include as part of the LLM output, a one to two word summary of content of the received LLM input.

The LLM input 1111 may also include a prompt 1103, which may include one or more of instructions 1104 that the LLM is to follow in executing the LLM input, the session caption 1105 determined from the session content items, the contextual metadata 1108 determined for the session content items, the response structure 1106 which may indicate how the LLM output is to be structured, and/or rules 1107 that are to be followed by the LLM in processing the LLM input. Continuing with the bathroom ideas, the instructions 1104 may include, for example:
You are a tasteful and perceptive interior designer for Company A. You are knowledgeable of all the latest trends and brands, with a focus on interesting and not mass-market items and have a principled stance on helping people find their own personal taste preference.
Imagine you have a client who is a company A user and has selected several content items. I am going to provide you with possible captions based on some of the client's selected content items.
The name of the client's collection of selected content items is “bathroom ideas,” and here are some possible captions based on some of the most recently saved content items for the client's collection:

In this example, the session captions 1105 included in the LLM input may include: “mediterranean, country, coastal, mediterranean: spanish, mediterranean: italian, mid-century modern, moroccan, bathroom design, bathroom interior, bathroom remodel, bathroom inspiration,” all of which may have been determined by a caption service, as discussed herein.

In some implementations, the LLM input 1111 may also include additional instructions 1104 as to how the LLM output is to be structured, etc. Continuing with the above example, the LLM input 1111 may include additional instructions 1104 specifying the structure of the LLM output:
Provide a response to the Company A user summarizing their taste preference and offering suggestions based on their collection of content items. Provide the response in JSON format adhering strictly to the following JSON schema and include all required properties:

```
###
,
                  “title”:,
                  “subtitle”:,
                  “descriptions”:,
                  “description_detail”:,
                  primary_taste_preference_names”:,
                    “min|terms”: 3,
                    “max|terms”: 3
                  }},
                  “query”:
                }},
          “required”: [“type”, “title”, “subtitle”, “description”,
          “description_detail”, “primary_taste_preference_names”]
              }},
            “min|terms”: 1
            “max|terms”: 1
        }}
      }},
    “required”: [“response”],
    “additionalProperties”: false
  }}
###
```

The rules 1107 for the LLM input may include, for example:
“taste_preference_summary” module: Imagine you're starting a thoughtful taste preference consultation. Provide a “title” that sums up this client's taste preference (e.g. “Relaxed industrial”, “Earthy minimalist”).
Define taste_preference_names as the 3 taste preferences that best describe this client: [“Modern minimalist”, “mid-century modern”, “traditional”].
The “description” will be one sentence that best captures this person's taste preference by breaking it down into 3 descriptors derived from taste_preference_names that best reflect the client's tastes.
The “primary_taste_preference_names” is a required field and contains the 3 taste preferences referenced in “description” and must be an exact match for an item in taste_preference_names.

As illustrated in the above example LLM input, any of a variety of captions, instructions, and/or rules may be included in the LLM input to help construct and guide the LLM in creating the LLM output.

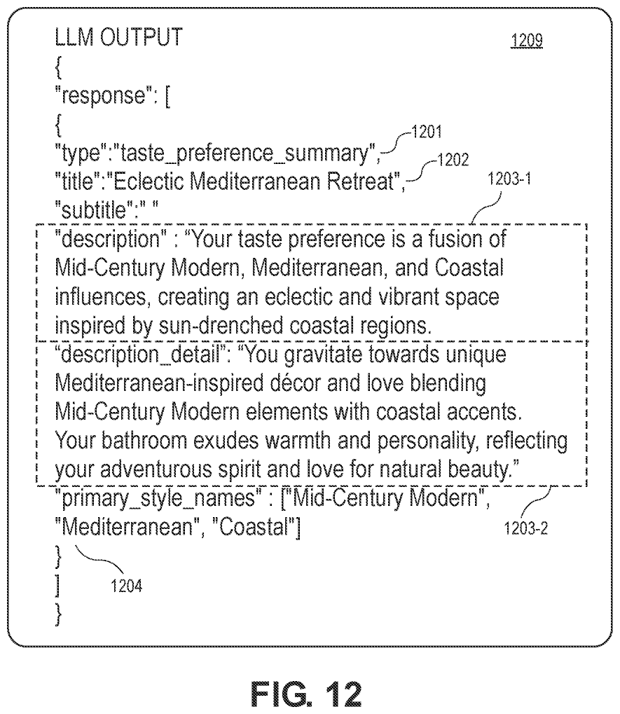

Returning to FIG. 8, upon generation of an LLM input, as discussed above, the LLM input may be provided to the LLM, as in 810, and the LLM may process the LLM input and return an LLM output that includes the requested information, such as a summary and descriptors, as in 812. For example, and referring to FIG. 12, the LLM, in response to receiving the example LLM input discussed above, may generate an LLM output 1209 that includes a response, such as type 1201 “taste_preference_summary”, a title 1202, such as “Eclectic Mediterranean Retreat,” and a description 1203-1, such as “Your taste preference is a fusion of Mid-Century Modern, Mediterranean, and Coastal influences, creating an eclectic and vibrant space inspired by sun-drenched coastal regions.” The LLM input may also include a description detail 1203-2 such as “You gravitate towards unique Mediterranean-inspired décor and love blending Mid-Century Modern elements with coastal accents. Your bathroom exudes warmth and personality, reflecting your adventurous spirit and love for natural beauty.” The LLM output 1209 may also include a list of primary taste preference names 1204, such as, “Mid-Century Modern,” “Mediterranean,” and “Coastal.” All of the example LLM outputs are provided in response to the LLM input that included the session context description, instructions, session caption, requested response structure, rules, etc.

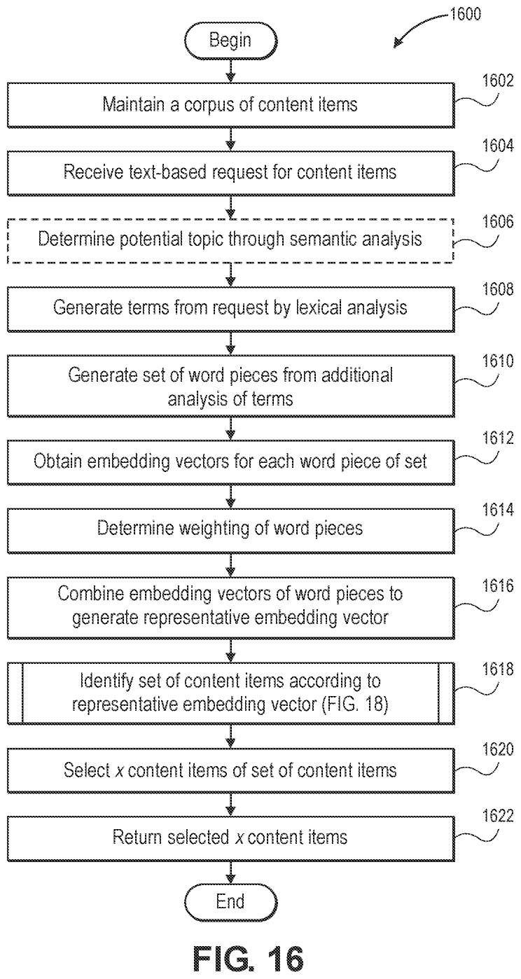

Returning again to FIG. 8, upon receiving the LLM output, the example process 800 may utilize some or all of the LLM output to determine content items from a corpus of content items based on the descriptions, as in 814. In some implementations, the example process 800 may also consider information known about the user, such as user preference, user history, etc., in determining the content items. As discussed further below, in some examples, the description included in the LLM output may be provided to a search query as a text request for content items. That text request may then be processed, for example as discussed below, to identify and return recommended content items from a corpus of content items as responsive to the text request. Details for processing a text request to determine and return selected content items is discussed further below with respect to FIG. 16.

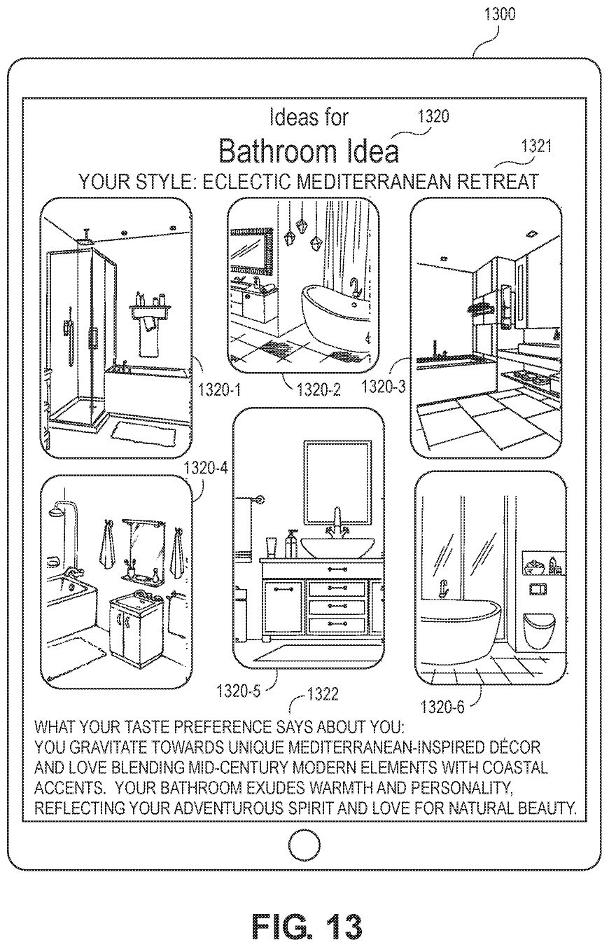

Finally, the example process 800 may generate and present a session output, as in 816. The session output may include both information from the LLM output, such as the title 1202 (FIG. 12) and the description detail 1203-2, as well as the content items determined from the corpus based on the description 1203-2 included in the LLM output. For example, FIG. 13 is an illustration of a session output 1300 generated and presented by the example process 800, in accordance with the disclosed implementations. As illustrated in FIG. 13, the session output 1300 includes a title 1321 that is obtained from the LLM output, in this example “Eclectic Mediterranean Retreat,” the description detail 1322 included in the LLM output “You gravitate towards unique Mediterranean-inspired décor and love blending Mid-Century Modern elements with coastal accents. Your bathroom exudes warmth and personality, reflecting your adventurous spirit and love for natural beauty.” and a plurality of content items that are selected from a corpus of content items based on the description 1203-2 (FIG. 12) included in the LLM output. In this example, six recommend content items 1320-1, 1320-2, 1320-3, 1320-4, 1320-5, and 1320-6 are returned by the example process as representative of the taste preference determined based on the content items originally selected by the user.

In some implementations, the example process 800 may also determine a merchant(s) that offers an item(s) or object represented in at least one of the recommended content items for sale. In such an implementation, the merchant may also be identified in the presentation so that the object represented in the one or more content items may be purchased through the merchant.

FIG. 9 is an example session caption process 900, in accordance with aspects of the disclosed subject matter.

The example process 900 begins with selection of one or more caption services that are to process the content items and output captions descriptive of those content items, as in 902. In some implementations, the example process 900 may only select one caption service. In other examples, multiple caption services may be selected. The one or more caption services may be, for example, BLIP-2, FLAMINGO80B. VQAv2, etc. and/or an internally maintained caption service. In some implementations, the caption service(s) may be selected based on the user, the content items selected, the quantity of content items selected, whether a caption is to be created for each content items, whether a caption is to be created as representative of all the content items, etc.

In some implementations, possible result captions that may be provided as outputs by the caption service may also be defined, as in 903. The content identifiers are then processed to generate session captions representation of the session content identifiers, as in 904.

If the selected caption service only generates a caption for each content item, the caption service may process each content item and generate a respective content identifier caption for each content item. Those content identifier captions may then be combined as a service caption for the session, as determined for the session content items. In other examples, a selected caption service may process all of the content items of the session content items and generate a service caption that is representative of the content items of the session content items. If more than one caption service is selected for use with the example process 900, the service caption output by each selected caption service may then be combined to generate the session caption that is representative of the session content items processed by the example process 900. Combining of individual content item captions to generate a service caption for the session content items and/or combining of service captions output by a plurality of caption services may be done by, for example, adding the terms of each caption together. In other examples, combining of captions may include only selecting terms that appear in two or more of the captions being combined, or only terms appearing in a majority of the captions combined, etc.

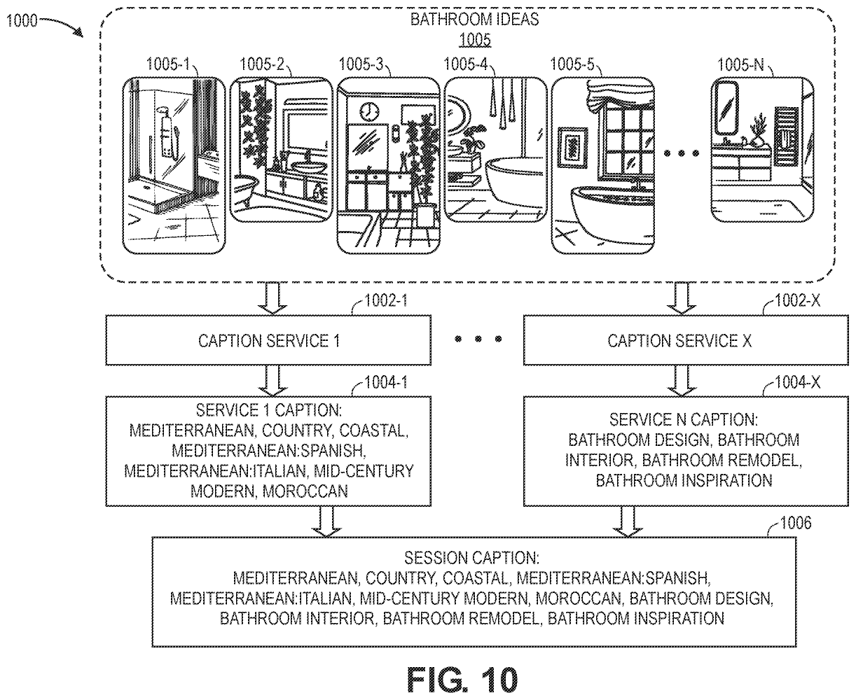

For example, FIG. 10 is an illustration 1000 of generating a session caption from session content items 1005 using a plurality of caption services 1002-1 through 1002-X, in accordance with disclosed implementations. In the example illustration 1000, the session content items 1005 include content items 1005-1, 1005-2, 1005-3, 1005-4, 1005-5, 1005-6, though 1005-N. The example process 900 (FIG. 9) selects X number of caption services 1002-1 through 1002-X and each caption service 1002-1 through 1002-X processes the session content items 1005. In the illustrated example, caption service 1 1002-1 generates service caption 1004-1 that includes the descriptions of “mediterranean, country, coastal, mediterranean: spanish, mediterranean: italian, mid-century modern, moroccan.” Likewise, the caption service X 1002-X processes the session content items 1005 and outputs a service caption 1004-X that includes the descriptors “bathroom design, bathroom interior, bathroom remodel, bathroom inspiration.” In this example, the session caption 1006 that is descriptive of the session content items 1005 is generated by combining the service captions 1002-1 through 1002-X to produce, as in 906 (FIG. 9). In the example illustrated in FIG. 10, the session caption 1006 that includes the descriptions of “mediterranean, country, coastal, mediterranean: spanish, mediterranean: italian, mid-century modern, moroccan, bathroom design, bathroom interior, bathroom remodel, bathroom inspiration” is generated by combining service caption 1004-1 through service caption 1004-X.

Returning to FIG. 9, upon generating a session caption, the session caption is returned, as in 908, and the example process 900 completes.

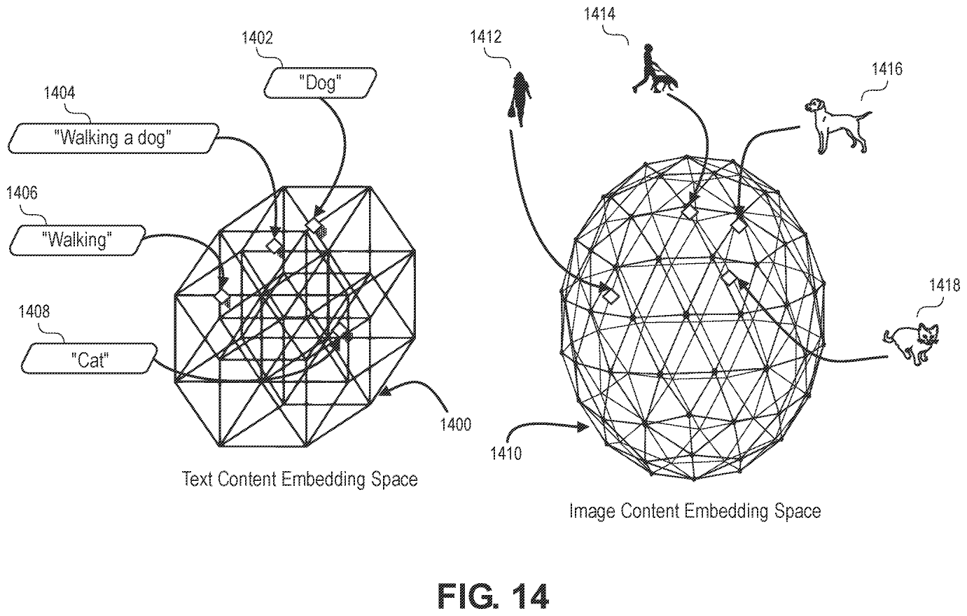

In implementations in which a text request is provided as the request or content items of the request are processed to generate a text request, as suggested above, embedding vector generators can be used to generate embedding vectors from the text request and project the embedding vectors into a suitable content embedding space. Generally speaking, an embedding vector generator trained to generate embedding vectors for text-based input generates embedding vectors that project into a text-based embedding space. Similarly, an embedding vector generator trained to generate embedding vectors for image-based input generates embedding vectors that project into an image-based embedding space. To further illustrate, FIG. 14 is a pictorial diagram illustrating the projection of items (via embedding vectors) into a type-corresponding embedding space. In particular, FIG. 14 illustrates that text-based queries 1402, 1404, 1406, 1408, via associated embedding vectors (i.e., the attached arrows), are projected into a text-based embedding space 1400, and that image-based content items 1412, 1414, 1416, 1418, via associated embedding vectors, are projected into an image-based embedding space 1410. For a networked hosting service that hosts hundreds of millions of images, such as the hosting service discussed, a mapping must be generated and maintained that maps text-based queries to a list of corresponding images. While this can be implemented, it requires substantial storage for the mappings, requires substantial processing bandwidth to periodically generate and maintain these mappings, and generally limits the number of images that can be associated with any given text-based query. Further, and perhaps more importantly, a hosting service often does not have enough information about longer queries and/or queries with typographical errors. For example, in a system that simply maintains mappings of queries to images, the query “dress” will most likely be mapped to a significant number of corresponding images, yet the query, “yellwo dress with orange and blue stripes,” will likely not be mapped at all since, perhaps, it has never been received before, and/or because of the misspelling, “yellwo.” However, according to aspects of the disclosed subject matter and as discussed herein, through the use of embedding vectors, the hosting service can project the embedding vector of the text-based request into an image-based embedding space to find relevant results.

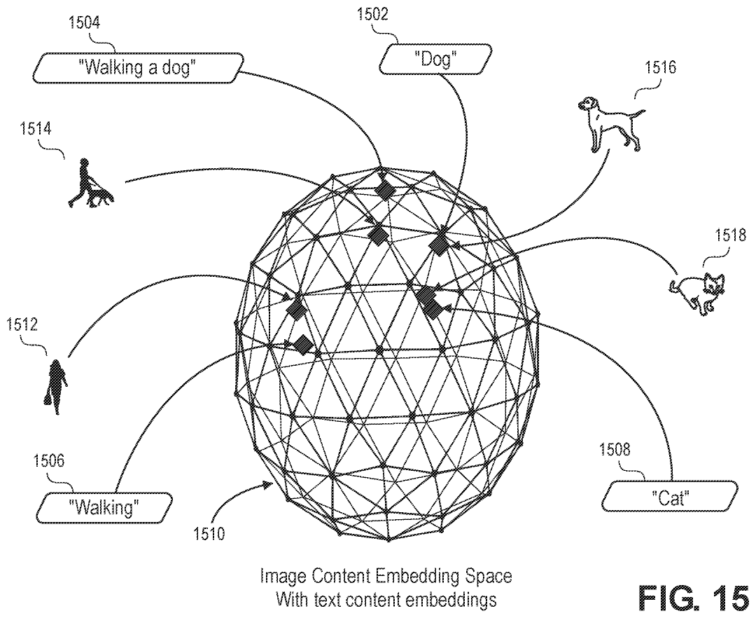

According to aspects of the disclosed subject matter, rather than training embedding vector generators to generate embedding vectors that project into an embedding space according to the input type (e.g., text-based embedding vectors that project into a text-based embedding space and image-based embedding vectors that project into an image-based embedding space), one or more embedding vector generators can be trained to generate embedding vectors for text-based queries that project the text-based queries directly into the image-based embedding space. Indeed, according to aspects of the disclosed subject matter, an embedding vector generator may be trained (either as a single instance or as part of an on-going training) by query/user interaction logs to generate embedding vectors for text-based queries into a non-text content item embedding space. FIG. 15 is a pictorial diagram illustrating the projection of items, including both images 1512, 1514, 1516, 1518 and text-based queries 1502, 1504, 1506, 1508, via associated embedding vectors, into an image-based embedding space 1510. Advantageously, this alleviates the additional processing requirements of generating mappings between queries and image content items, of limited number of mappings between queries and the corresponding image content items, and in maintaining the mapping tables as the corpus of image content items 134 is continually updated.

Regarding the projection of text-based content (e.g., text-based queries 1502-1508), it should be appreciated that some text-based content will be projected, via an associated embedding vector, to the same location as an image, as is the illustrated case with text-based query 1502 “Dog” and image 1516. In other instances, text-based content may be projected, via an associated embedding vector, to a location that is near an image projected into the embedding space that, at least to a person, appears to be the same subject matter. For example, text-based query 1504 “Walking a dog” is projected near to, but not to the same location as the projection of image 1514. This possibility reflects the “freedom” of the trained embedding vector generator to differentiate on information that may or may not be apparent to a person, a common “feature” of machine learning.

To further illustrate the process of responding to a text-based request with a response containing one or more non-text content items, reference is now made to FIG. 16. FIG. 16 is a flow diagram illustrating an exemplary routine 1600 for returning one or more content items, particularly non-text content items, in response to a text-based query/request, in accordance with aspects of the disclosed subject matter. Beginning at block 1602, a hosting service maintains a corpus of content items the service can draw from in response to a request.

In accordance with aspects of the disclosed subject matter, content items of the corpus of content items, such as corpus 134 of content items, are non-text content items. By way of illustration and not limitation, non-text content items may comprise images, video content, audio content, data files, and the like. Additionally, and/or alternatively, a content item may be an aggregation of several content types (e.g., images, videos, data, etc.) and textual content-though not an aggregation of only text content. Additionally, while content items are non-text content items, these content items may be associated with related textual content. Typically, though not exclusively, related textual content associated with a content item may be referred to as metadata. This textual metadata may be any number of text-based sources such as, by way of illustration and not limitation, source file names, source URL (uniform resource locator) data, user-supplied comments, titles, annotations, and the like.

According to aspects of the disclosed subject matter and, in maintaining the corpus of content items, such as the corpus 134 of content items illustrated in FIG. 1, each content item is associated with a corresponding embedding vector, or may be associated with an embedding vector in a just-in-time manner, the embedding vector projecting the corresponding content item into a content item embedding space. Further, and according to various aspects of the disclosed subject matter, each content item of the corpus of content items may be associated with a node in a content item graph. With additional reference to FIG. 17. FIG. 17 is a block diagram illustrating an exemplary content item graph 1700 of content items from a corpus of content items, configured according to aspects of the disclosed subject matter, such as the corpus 134 of FIG. 1.

As will be readily appreciated by those skilled in the art, a content item graph, such as content item graph 1700, includes nodes and edges, where each node corresponds to a content item of the corpus of content items, and an edge represents a relationship between two nodes corresponding to two distinct content items of the content graph. By way of illustration, nodes in the content item graph 1700 are represented as circles, including nodes A-L, and relationships are presented as lines between nodes, such as relationships 1701, 1703, 1705, 1707, 1709. There may be multiple bases for relationships between content items which include, by way of illustration and not limitation, co-occurrence within a collection of content items, commonality of ownership of content items, user engagement of content items, similarity between content items, and the like.

In regard to routine 1600, at block 1604 the hosting service receives a text-based request for content items, such as a text-based request generated as discussed above. According to aspects of the disclosed subject matter, the text-based request comprises one or more text-based terms that, collectively, provide information to the hosting service 130 to identify content items from its corpus of content items that are viewed as related, relevant, and/or generally responsive to the request.

At block 1606, an optional step may be taken to conduct a semantic analysis of the received request. According to aspects of the disclosed subject matter and by way of definition, this optional semantic analysis processes the terms of the request, including identifying syntactic structures of terms, phrases, clauses, and/or sentences of the request to derive one or more meanings or intents of the subscriber's request. As should be appreciated, one or more semantic meanings or intents of the request may be used to identify a specific set of content items for terms of the search request that may have multiple meanings, interpretations or intents.

At block 1608, the received request is processed to generate a set of terms of the request. Typically, though not exclusively, the terms are processed by a lexical analysis that parses the request according to white space to identify the various terms. In addition to the parsing of the request, spell correction, expansion of abbreviations, and the like may occur in order to generate the set of terms for the received request.

At block 1610, a morphological analysis is conducted to generate a set of word pieces from the set of text-based terms of the request. According to at least some implementations of the disclosed subject matter, at least one term of the text-based request includes at least two word pieces. According to various implementations of the disclosed subject matter, the word pieces are generated according to and comprise the various parts of a word including, but not limited to: e.g., a prefix, a suffix, a prefix of a suffix, a stem, and/or a root (or roots) of a word to term, as well as sub-strings of the same. Indeed, all parts of a term are found in a word piece for that term. Additionally, and according to further aspects of the disclosed subject matter, word pieces that are not the leading characters of a term are identified. To illustrate, for the word/term “concatenation,” the word pieces generated would be “conca,” “##tena,” and “##tion,” with the characters, “##,” included for designating that the following word piece was not found at the beginning of the term. According to alternative aspects of the disclosed subject matter, each word piece within the set of word pieces is a morpheme of at least one of the terms of the set of text-based terms of the request.

Regarding the word parts, the text terms “running” may be broken down into two word pieces: “run” being the root, and “##ing” being a suffix indicative of something actively running. A lexical or etymological analysis may be conducted to identify the various word parts of each term, where each word part is viewed as a “word piece.”

Regarding morphemes and by way of definition, a morpheme (or word piece) is the smallest meaningful unit in a language and is a part of a word/term. A morpheme is not identical to a word: a word includes one or more morphemes and a morpheme may also be a complete word. By way of illustration and not limitation, “cat” is a morpheme that is also a word. On the other hand, “concatenation” is a word comprising multiple morphemes: “con.” “catenate” and “tion,” where “catenate” is a completed form of “catena.” completed as part of generating the word pieces. The identifiers indicating that the word piece does not comprise the leading characters of the term may, or may not be included, as determined according to implementation requirements.

According to various implementations of the disclosed subject matter, the morphological analysis may be conducted by an executable library or service, and/or a third-party service, that examines a given word and provides the morphemes for that given word. In various alternative implementations, a word/morpheme list cache may be utilized to quickly and efficiently return one or more morphemes of a given input word.

In yet a further implementation of the disclosed subject matter, various technologies, such as Byte Pair Encoding (BPE), may be used to generate word pieces for the text-based terms of the text-based request. Generally speaking, these various technologies, including BPE, operate on a set of statistical rules based on some very large corpus text. As those skilled in the art will appreciate, BPE is often used as a form of data compression in which the most common consecutive characters of input data are replaced with a value that does not occur within that data. Of course, in the present instance, the BPE process does not replace the consecutive characters in the term itself, but simply identifies the consecutive characters as a word piece.

At block 1612, embedding vectors for each of the word pieces of the set of word pieces is obtained. According to aspects of the disclosed subject matter, the embedding vectors are content item embedding vectors, meaning that the embedding vectors project the corresponding word piece into the content item embedding space of the content items in the corpus of content items.

According to various implementations of the disclosed subject matter, a content item embedding vector of a given word piece may be generated in a just-in-time manner by a suitably trained embedding vector generator. According to additional and/or alternative implementations, previously generated and cached content item embedding vectors may be retrieved from a cache of the hosting service configured to hold word piece-embedding vector pairs.

At block 1614, weightings for the various word pieces of the set of word pieces are optionally determined. Weightings may be optionally applied to emphasize important word pieces of a request. These weightings may be determined, by way of illustration and not limitation, according to the importance of the word pieces themselves, the determined potential topic of the requesting subscriber (as optionally determined in block 1606), multiple instances of a word piece among the terms of the request, and the like.

At block 1616, the embedding vectors of the word pieces are combined to form a representative embedding vector for the request. According to various implementations of the disclosed subject matter, the various embedding vectors may be averaged together to form the representative embedding vector. Optionally, the weightings determined in block 1612 may be applied in averaging of the various embedding vectors to favor those word pieces of the set of word pieces that are viewed as being more important to the request.

According to implementations of the disclosed subject matter, the text-based request and the representative embedding vectors may be stored in a cache, so that subsequent instances of receiving the same text-based request may be optimized through simple retrieval of the corresponding representative embedding vector. Of course, if there is no entry for a particular request, or if the implementation does not include a text request-embedding vector cache, the representative embedding vector for a text-based request may be generated in a just-in-time manner.

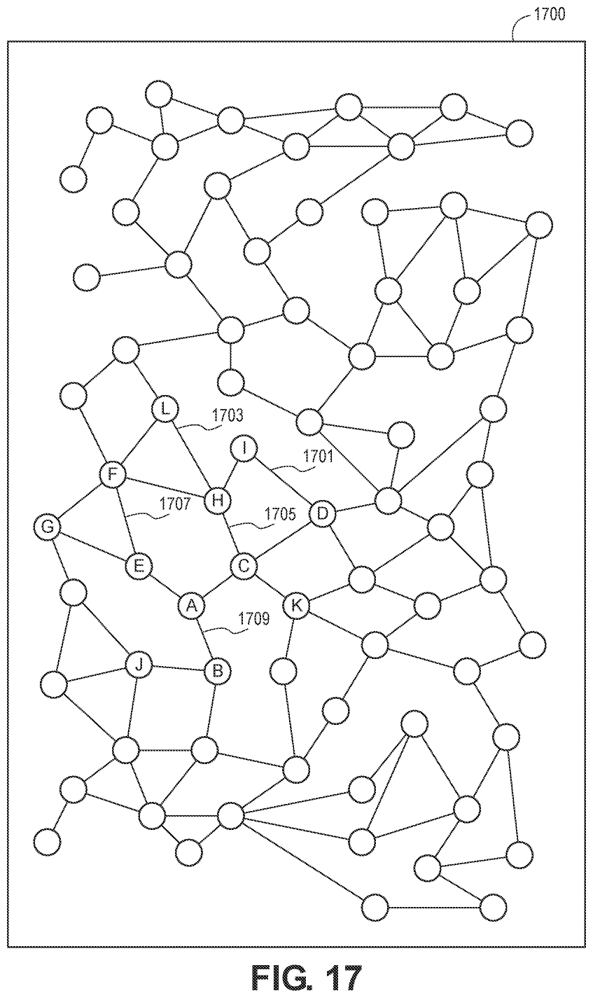

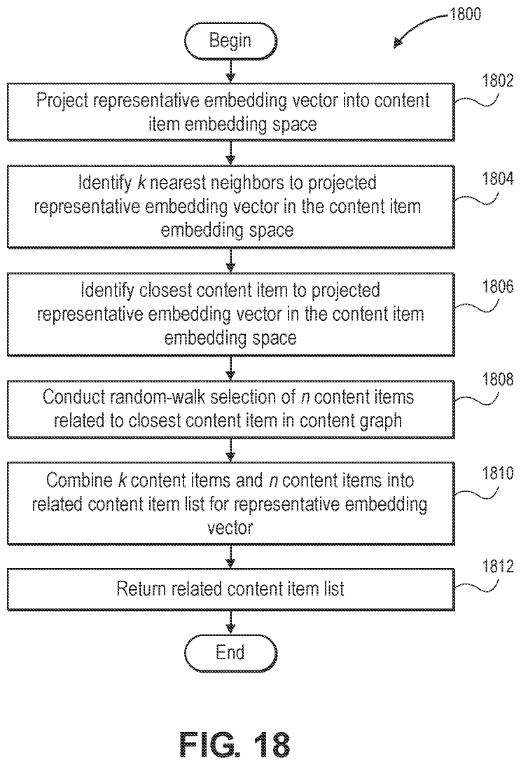

With the representative embedding vector for the request determined from embedding vectors of the word pieces, at block 1618 a set of content items is determined from the corpus of content items. A description of determining a set of content items from the corpus of content items is set forth in more detail in regard to routine 1800 of FIG. 18. Indeed, with reference to that figure, FIG. 18 is a flow diagram illustrating an exemplary routine 1800 for determining a set of content items for a representative embedding vector, in accordance with aspects of the disclosed subject matter.

Beginning at block 1802, the representative embedding vector for the word pieces is projected into the content item embedding space. At block 1804, with the content items of the corpus of content items projected into the content item embedding space, a set of k content items, also commonly referred to as the nearest neighbors to the projected representative embedding vector, are identified. More particularly, this set of k content items whose projection into the content item embedding space are closest, according to the distance measurement, to the projection of the representative embedding vector are selected. In various implementations of the disclosed subject matter, the distance measurement of embedding vectors is a cosine similarity measurement. Of course, other similarity measures may alternatively be utilized such as, by way of illustration and not limitation, the Normalized Hamming Distance measure, a Euclidian distance measure, and the like. In various implementations of the disclosed subject matter, the value of k may correspond to any particular number as may be viewed as a good representation of close content items to the representative embedding vector. In various non-limiting implementations, the value of k may be twenty. Of course, in alternative implementations, the value of k may be higher or lower than twenty.

At block 1806, a closest content item of the corpus of content items to the projected representative embedding vector (often included among the k nearest neighbors) is identified. This closest content item may be used as an “origin” of a random-walk to identify a set of n related content items within the content item graph in which the content items of the corpus of content items are represented.

As described in greater detail in co-pending and commonly assigned U.S. patent application Ser. No. 16/101,184, filed Aug. 10, 2018, which is incorporated herein by reference, and according to aspects of the disclosed subject matter, a random-walk selection relies upon the frequency and strength of edges between nodes in a content item graph, where each edge corresponds to a relationship between two content items. As mentioned above, a “relationship” between two content items in a content item graph represents a relationship between the two content items, such as, by way of illustration and not limitation, co-occurrence within a collection, common ownership, frequency of access, and the like.

At block 1808 and according to aspects of the disclosed subject matter, a random-walk selection is used to determine a set of n related content items. This random-walk selection utilizes random selection of edge/relationship traversal between nodes (i.e., content items) in a content item graph, such as content item graph 1700, originating at the closest content item to the projected representative embedding vector. By way of illustration and not limitation, and with returned reference to FIG. 17, assume that the closest content item to the projected representative embedding vector corresponds to node A in the content item graph 1700.

According to further aspects of the disclosed subject matter, in a random-walk, a random traversal is performed, starting with an origin, e.g., node A, in a manner that limits the distance/extent of accessed content items reached in a random traversal of the content items of the content item graph 1700 by resetting back to the original content item after several traversals. Strength of relationships (defined by the edges) between nodes is often, though not exclusively, considered during random selection to traverse to a next node. Indeed, a random-walk selection of “related nodes” relies upon frequency and strength of the various edges to ultimately identify the second set of n content items of the content item graph 1700. These “visited” nodes become candidate content items of the n content items that are related to the origin content item. At the end of several iterations of random walking the content item graph 1700 from the origin (e.g., node A), a number of those nodes (corresponding to content items) that have been most visited become the n content items of the set of related content items. In this manner, content items close to the original content item that have stronger relationships in the content item graph are more likely included in this set of n content items. While the value of n may correspond to any particular number as may be viewed as a good representation of close content items, in various non-limiting implementations, the value of n may be twenty-five. Of course, in alternative implementations, the value for n may be higher or lower than twenty-five.

At block 1810, the set of k content items and the set of n content items (which may share common content items) are combined into a related content item list for the representative embedding vector. According to various aspects of the disclosed subject matter, the combining process may include removing duplicate instances of the same content item in the related content item list.

At block 1812, the related content item list is returned. Thereafter, routine 1800 terminates.

While routine 1800 describes the use of a combination of two techniques for identifying content, i.e., k nearest neighbors (often referred to as kNN) and random walk, it should be appreciated that in any given implementation, either or both techniques may be used when obtaining content for a user's request from a representative embedding vector generated from word pieces of the text-based request. Accordingly, the discussion of using both techniques in routine 1800 should be viewed as illustrative and not limiting upon the disclosed subject matter.

With returned reference to routine 1600, after obtaining the related content item list, at block 1620 a set of x content items from the related content item list are selected as content items to be returned as a response to the request. At block 1622, the selected x content items are returned. Thereafter, routine 1600 terminates.

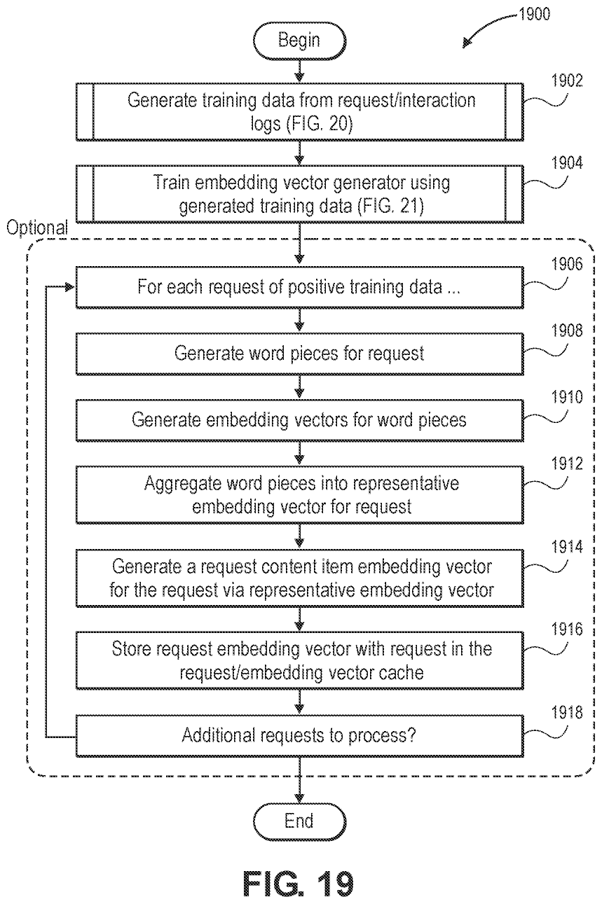

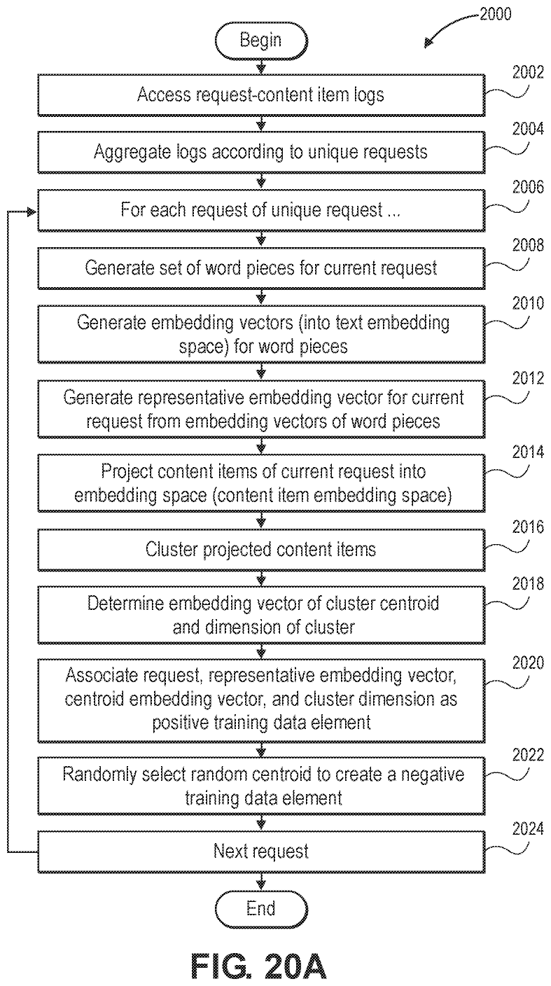

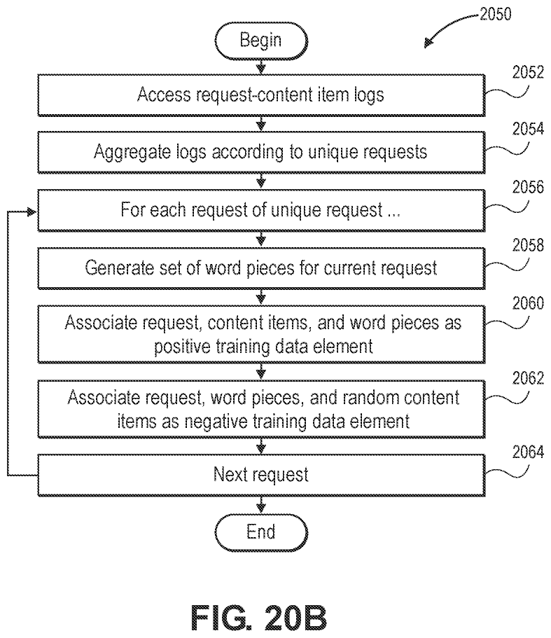

As indicated above, a trained embedding vector generator is used to generate embedding vectors into a content item embedding space for word pieces. FIG. 19 illustrates an exemplary routine 1900 for training a machine learning model to generate embedding vectors into a content item embedding space for a text-based request, in accordance with aspects of the disclosed subject matter. Beginning at block 1902, a set of training data is generated, comprising both positive training tuples and negative training tuples. Each training tuple comprises a text-based request, a representative embedding vector generated from word pieces of the text-based request, a centroid embedding vector projecting the text-based request (using the representative embedding vector) to a location in the content item embedding space, and a distance measure to identify content items that are viewed as falling within the neighborhood area of the centroid. Regarding the generation of these training tuples, reference is made to FIGS. 20A and 20B.

FIG. 20A demonstrates a flow diagram illustrating an exemplary routine 2000 for generating training data for training a machine learning model to generate an embedding vector for a text-based query from a representative embedding vector generated from word pieces of the text-based query, and in accordance with aspects of the disclosed subject matter. At block 2002, a set of request/content item logs that are maintained by the hosting service are accessed. These request/content item logs include request/content item pairs corresponding to a text-based request by a subscriber and one or more content items with which the requesting subscriber interacted, indicative of a positive interaction on the part of the subscriber with the content items resulting from the request.

At block 2004, the request/content item logs are aggregated according to unique requests. In this aggregation, there may be (and will likely be) multiple content items associated with a unique, text-based request. Each of these content items represents a positive relationship to the text-based request.

At block 2006, an iteration loop is begun to iterate through and process the unique requests of the request/content item logs, to generate training data for training a machine learning model to generate embedding vectors for text-based requests into the content item embedding space. Thus, at block 2008 and with regard to a currently iterated request (with corresponding content items), a set of word pieces for the text-based request is generated. As suggested above, these word pieces may correspond to parts of the words, or, in the alternative, correspond to morphemes. At block 2010, embedding vectors are generated for each of the word pieces. According to aspects of the disclosed subject matter, the embedding vectors generated from the word pieces are embedding vectors into a text-based/word-pieces embedding space, not the content item embedding space.

At block 2012, a representative embedding vector (into the text-based/word-pieces embedding space) is generated for the request from the embedding vectors of the word pieces. Typically, though not exclusively, the word pieces embedding vectors are averaged together to form the representative embedding vector. Weighting for word pieces that are viewed as more important, e.g., root portions of word pieces, post-fixes that indicate activity, etc., may be given more weight when forming the resulting representative embedding vector.

With the representative embedding vector generated for the request, at block 2014, the content items associated with the currently iterated text-based request are projected (logically) into the multi-dimensional content item embedding space. At block 2016, the projected content items are clustered to identify a type of “neighborhood” in which a content item positively represents the text-based request. At block 2018, a centroid for the cluster is identified, along with dimensional information of the cluster.

At block 2020, the text-based request, the representative embedding vector, a centroid embedding vector of the cluster's centroid, and the cluster's dimensional data are stored as a positive training data element for training the machine learning model. Since negative training elements are also needed, at block 2022, an embedding vector in the content item space that points outside of the cluster is used to replace the centroid embedding vector and saved as a negative training element.

Regarding blocks 2016-2020, while these blocks describe the identification of a centroid of a cluster, and using the representative embedding vector, the centroid, and some measure of the cluster's dimensions as a positive training data element, in alternative implementations, each image projected in the image-based embedding space within the generated cluster is paired with the representative embedding vector and the cluster's dimensional data is stored as a positive training data element for training the machine learning model. In still further alternative implementations, a simple, predefined distance measure from the centroid may be used, rather than cluster dimensions.

At block 2024, if there are additional unique requests to process in the iteration, the routine 2000 returns to block 2006 to process the next unique, text-based request from the request/content item logs. Alternatively, if there are no more requests to process in the iteration, routine 2000 terminates, having generated both positive and negative training data/tuples.

As those skilled in the art will appreciate, there are often numerous ways to generate training data to train a machine learning model. In this regard, FIG. 20B demonstrates another flow diagram illustrating an alternative exemplary routine 2050 for generating training data for training a machine learning model to generate an embedding vector for a text-based query from word pieces of the text-based query, all in accordance with various aspects of the disclosed subject matter.

Beginning at block 2052, a set of request/content item logs that are maintained by the hosting service are accessed. As indicated above, these request/content item logs include request/content item pairs corresponding to a text-based request by a subscriber and one or more content items with which the requesting subscriber interacted, where the one or more content items are viewed as being indicative of a positive interaction on the part of the subscriber resulting from the request. At block 2054, the request/content item logs are aggregated according to unique requests among all the requests, and further combined with the content items of each instance of a request. Of course, in this aggregation, there may be (and will likely be) multiple content items associated with a unique, text-based request. As mentioned, each of these content items represents a positive relationship to the text-based request.

At block 2056, an iteration loop is begun to iterate through and process the unique requests of the request/content item logs, to generate training data for training a machine learning model to generate embedding vectors for text-based requests into the content item embedding space. Thus, at block 2058 and with regard to a currently iterated text-based request (with corresponding content items), a set of word pieces for the text-based request is generated. As suggested above, these word pieces may correspond to parts of the words (terms of the text-based request) or, in alternative implementations, correspond to morphemes of the text terms of the text-based request.

At block 2060, the currently processed request, the content items that are associated with the currently processed request, and the word pieces are stored as a positive training element. As an alternative to generating a single training element that is associated with multiple content items, multiple positive training elements may be generated from the request and word pieces, each of the multiple positive training elements being associated with one of the content items of the multiple content items associated with the currently processed request along with the request and set of word pieces.

At block 2062, the currently processed request, a set of randomly selected content items, and the word pieces are stored as a negative training element. Touching on the alternative mentioned in regard to block 2060, multiple negative training elements may be generated, with each negative training element being associated with a single, randomly-selected content item.

At block 2064, if there are additional unique requests to process in the iteration, the routine 2050 returns to block 2056 to process the next unique, text-based request from the request/content item logs. Alternatively, if there are no more requests to process in the iteration, routine 2050 terminates, having generated both positive and negative training data/tuples.

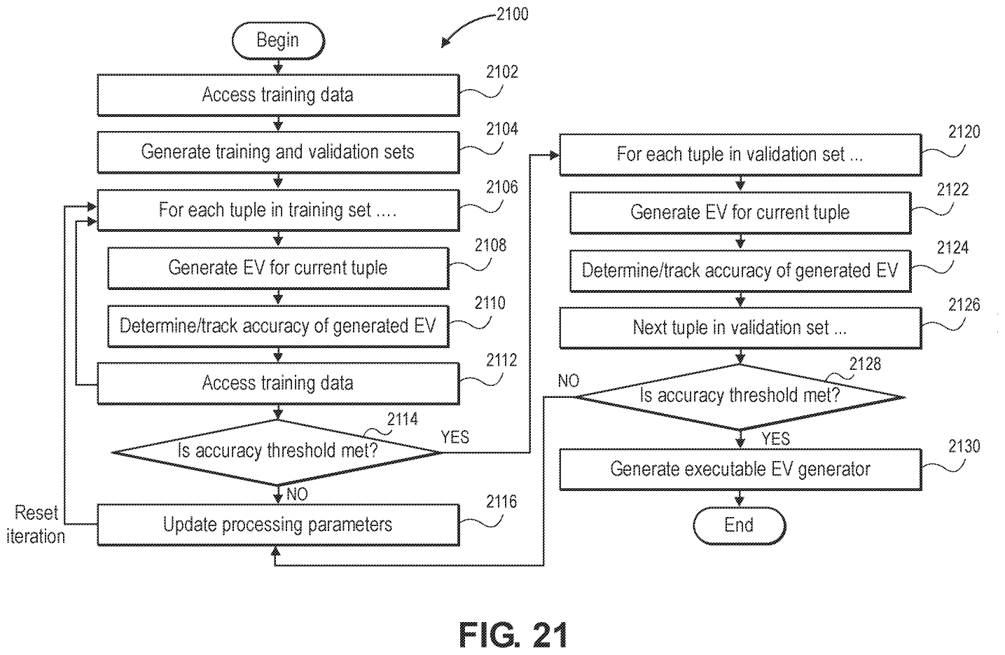

Returning to routine 1900, after generating positive and negative training tuples from the request/content item logs, at block 1904, a machine learning model, such as a deep neural network and/or a convolutional neural network, is trained as an embedding vector generator to generate embedding vectors into a content item embedding space for text-based requests according to the word pieces of the requests. This training of the embedding vector generator is made according to the positive and negative training tuples, i.e., the training data, as may have been generated in routine 2000. A generalized routine for training a machine learning model is set forth below in regard to routine 2100 of FIG. 21.

After training an embedding vector generator that generates embedding vectors into a content item embedding space for text-based requests, optional steps may be taken. More particularly, at block 1906, an iteration loop may be carried out to iterate through the unique text-based requests of the request/content item logs in order to pre-generate and cache the results. Thus, at block 1908 and with regard to a currently iterated text-based request, word pieces for the request are generated. At block 1910, embedding vectors (into a text-based embedding space) are generated for the word pieces. At block 1912, the word pieces are aggregated to form a representative embedding vector (into the text-based embedding space) for the request. At block 1914, a request embedding vector is generated that projects the representative embedding vector of the request into the content item embedding space. At block 1916, the request and the request embedding vector are stored in the text request-embedding vector cache.

At block 1918, if there are any additional unique requests to process, the iteration returns to block 1906 for further processing. Alternatively, if there are no more unique requests to process and cache, the routine 1900 terminates.

Turning now to FIG. 21, FIG. 21 is a flow diagram illustrating an exemplary, generalized routine 2100 for training a machine learning model to generate content item embedding vectors for word pieces, in accordance with aspects of the disclosed subject matter. As mentioned above, the training is based on the training of tuples of a word piece, an embedding vector, and a distance measure, such as those generated in routine 2000 of FIG. 20.

Beginning at block 2102, the training data (comprising both positive and negative training tuples) is accessed. At block 2104, training and validation sets are generated from the training data. These training and validation sets comprise a training tuple randomly selected from the training data, while retaining whether a given training tuple is a positive or negative training tuple.

As those skilled in the art will appreciate, the purpose of both training and validation sets is to carry out training phases of a machine learning model (in this instance, an embedding vector generator) by a first phase of repeatedly training the machine learning model with the training set until an accuracy threshold is met, and a second phase of validating the training of the machine learning model with the validation set to validate the accuracy of the training phase. Multiple iterations of training and validation may, and frequently do occur. Typically, though not exclusively, the training and validation sets include about the same number of training tuples. Additionally, as those skilled in the art will appreciate, a sufficient number of training tuples should be contained within each set to ensure proper training and validation, since using too few may result in a high level of accuracy among the training and validation sets, but a low level of overall accuracy in practice.

With the training and validation sets established, at block 2106, an iteration loop is begun to iterate through the training tuples of the training set. At block 2108, a content item embedding vector is generated by a machine learning model for the word piece of the currently iterated tuple. At block 2110, the accuracy of the embedding vector for the word piece of the currently iterated tuple is determined based on the centroid embedding vector of the word piece of the currently iterated tuple, the distance measure. For example, if the content item embedding vector generated for the currently iterated tuple is within the distance measure of the embedding vector of the tuple, the tracking would view this as an accurate embedding vector generation. On the other hand, if the embedding vector generated for the currently iterated tuple is outside of the distance measure of the centroid embedding vector of the tuple, the tracking would view this as an inaccurate embedding vector generation.

After determining and tracking the accuracy of the machine learning model on the currently iterated tuple, at block 2112 if there are additional tuples in the training set to be processed, the routine 2100 returns to block 2106 to select and process the next tuple, as set forth above. Alternatively, if there are no additional tuples in the training set to be processed, the routine 2100 proceeds to decision block 2114.

At decision block 2114, a determination is made as to whether a predetermined accuracy threshold is met by the current training state of the machine learning model in processing the tuples of the training set. This determination is made according to the tracking information through processing the tuples of the training data. If the in-training machine learning model has not at least achieved this predetermined accuracy threshold, the routine 2100 proceeds to block 2116.

At block 2116, the processing parameters that affect the various processing layers of the in-training machine learning model, including but not limited to the convolutions, aggregations, formulations, and/or hyperparameters of the various layers, are updated, and the routine 2100 returns to block 2106, thereby resetting the iteration process on the training data in order to iteratively continue the training of the in-training machine learning model.

With reference again to decision block 2114, if the predetermined accuracy threshold has been met by the in-training machine learning model, routine 2100 proceeds to block 2120. At block 2120, an iteration loop is begun to process the tuples of the validation set, much like the processing of the tuples of the training set.

At block 2122, an embedding vector (that projects into the content item embedding space) is generated by the machine learning model for the currently iterated tuple of the validation set. At block 2124, the accuracy of the in-training machine learning model is determined and tracked. More particularly, if the embedding vector generated for the currently iterated tuple (of the validation set) is within the distance measure of the embedding vector of the tuple, the tracking would view this as an accurate embedding vector generation. On the other hand, if the embedding vector generated for the currently iterated tuple is outside of the distance measure of the centroid embedding vector of the tuple, the tracking would view this as an inaccurate embedding vector generation.

At block 2126, if there are additional tuples in the validation set to be processed, the routine 2100 returns to block 2120 to select and process the next tuple of the validation set, as described forth above. Alternatively, if there are no additional tuples to be processed, the routine 2100 proceeds to decision block 2128.

At decision block 2128, a determination is made as to whether a predetermined accuracy threshold, which may or may not be the same predetermined accuracy threshold as used in decision block 2114, is met by the machine learning model in processing the tuples of the validation set. This determination is made according to the tracking information aggregated in processing the tuples of the validation set. If the in-training machine learning model has not at least achieved this predetermined accuracy threshold, then routine 2100 proceeds to block 2116.

As set forth above, at block 2116, the processing parameters of the in-training machine learning model, including but not limited to the convolutions, aggregations, formulations, and/or hyperparameters, are updated and the routine 2100 returns to block 2106, resetting the iteration process in order to restart the iterations with the training tuples of the training set.

In the alternative, at decision block 2128, if the accuracy threshold has been met (or exceeded), it is considered that the machine learning model has been accurately trained and the routine 2100 proceeds to block 2130. At block 2130, an executable embedding vector generator is generated from the now-trained machine learning model.

As those skilled in the art will appreciate, the in-training version of the machine learning model will include elements that allow its various levels, processing variables and/or hyperparameters to be updated. In contrast, an executable embedding vector generator is generated such that those features that allow the in-training machine learning model to be updated and “trained” are removed without modifying the trained functionality of the now-trained machine learning model. Thereafter, the routine 2100 terminates.

In accordance with additional aspects and implementations of the disclosed subject matter, a computer-executed method is set forth for providing content items to a subscriber of an online hosting service. A corpus of content items is maintained by the hosting service. In maintaining this corpus of content items, each content item is associated with an embedding vector that projects the associated content item into a content item embedding space. A text-based request for content from the corpus of content items is received from a subscriber of the hosting service, and the text-based request includes one or more text-based terms. A set of word pieces is generated from the one or more text-based terms. In some implementations, the set of word pieces includes at least two word pieces generated from at least one text-based term. An embedding vector is obtained for each word piece of the set of word pieces. Regarding the embedding vectors, each embedding vector for each word piece projects a corresponding word piece into the content item embedding space. With the embedding vectors obtained, the embedding vectors of the word pieces of the set of word pieces are combined to form a representative embedding vector for the set of word pieces. A set of content items of the corpus of content items is then determined according to or based on a projection of the representative embedding vector for the set of word pieces into the content item embedding space. At least one content item is selected from the set of content items of the corpus of content items and returned in response to the text-based request.

In accordance with additional aspects and implementations of the disclosed subject matter, computer-executable instructions, embodied on computer-readable media, a method of a hosting service is presented that responds to a text-based request with one or more content items. A corpus of content items is maintained by the hosting service. In maintaining this corpus of content items, each content item is associated with an embedding vector that projects the associated content item into a content item embedding space. A text-based request for content from the corpus of content items is received, and the text-based request includes one or more text-based terms. A set of word pieces is generated from the one or more text-based terms. In some but not all implementations, the set of word pieces includes at least two word pieces generated from at least one text-based term. An embedding vector is obtained for each word piece of the set of word pieces. Regarding the embedding vectors, each embedding vector for each word piece projects a corresponding word piece into the content item embedding space. With the embedding vectors obtained, the embedding vectors of the word pieces of the set of word pieces are combined to form a representative embedding vector for the set of word pieces. A set of content items of the corpus of content items is then determined according to or based on a projection of the representative embedding vector for the set of word pieces into the content item embedding space. At least one content item is selected from the set of content items of the corpus of content items and returned in response to the text-based request.

According to additional aspects of the disclosed subject matter, a computer system that provides one or more content items in response to a request is presented. In execution, the computer system is configured to, at least, maintain an embedding vector associated with each content item of a corpus of content items, each embedding vector suitable to project the associated content item into a content item embedding space. A text-based request for content items of the corpus of content items is received. The request comprises one or more text-based terms and a set of word pieces is generated from the one or more text-based terms. As discussed herein, the set of word pieces includes at least two word pieces generated from at least one text-based term of the received request. An embedding vector is obtained for each word piece of the set of word pieces, such that each embedding vector for each word piece projects a corresponding word piece into the content item embedding space. The embedding vectors of the word pieces of the set of word pieces are combined to form a representative embedding vector for the set of word pieces. A set of content items of the corpus of content items is then determined based on and/or according to a projection of the representative embedding vector for the set of word pieces into the content item embedding space. At least one content item from the set of content items of the corpus of content items is selected and returned to the subscriber in response to the request.

Regarding routines 500, 800, 900, 1600, 1800, 1900, 2000, 2050 and 2100 described above, as well as other routines and/or processes described or suggested herein, while these routines/processes are expressed in regard to discrete steps, these steps should be viewed as being logical in nature and may or may not correspond to any specific, actual and/or discrete execution steps of a given implementation. Also, the order in which these steps are presented in the various routines and processes, unless otherwise indicated, should not be construed as the only or best order in which the steps may be carried out. Moreover, in some instances, some of these steps may be combined and/or omitted.

Optimizations of routines may be carried out by those skilled in the art without modification of the logical process of these routines and processes. Those skilled in the art will recognize that the logical presentation of steps is sufficiently instructive to carry out aspects of the claimed subject matter irrespective of any specific development or coding language in which the logical instructions/steps are encoded. Additionally, while some of these routines and processes may be expressed in the context of recursive routines, those skilled in the art will appreciate that such recursive routines may be readily implemented as non-recursive calls without actual modification of the functionality or result of the logical processing. Accordingly, the particular use of programming and/or implementation techniques and tools to implement a specific functionality should not be construed as limiting upon the disclosed subject matter.

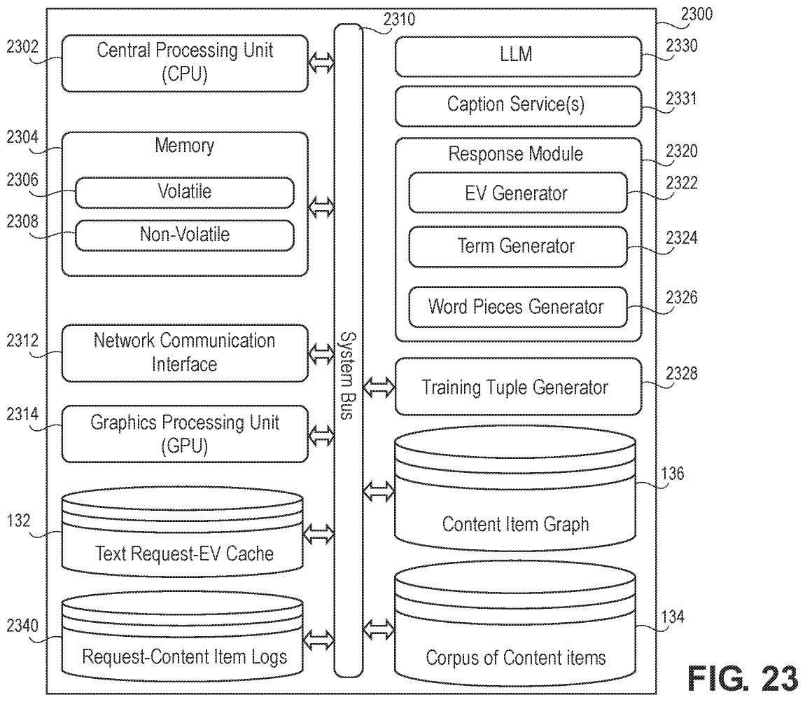

Of course, while these routines and/or processes include various novel features of the disclosed subject matter, other steps (not listed) may also be included and carried out in the execution of the subject matter set forth in these routines, some of which have been suggested above. Those skilled in the art will appreciate that the logical steps of these routines may be combined or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computer system described in FIG. 23 below. Additionally, in various implementations, all or some of the various routines may also be embodied in executable hardware modules including, but not limited to, systems on chips (SoC's), codecs, specially designed processors and/or logic circuits, and the like.

As suggested above, these routines and/or processes are typically embodied within executable code segments and/or modules comprising routines, functions, looping structures, selectors and switches such as if-then and if-then-else statements, assignments, arithmetic computations, and the like that, in execution, configure a computing device to operate in accordance with the routines/processes. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in executable instructions embodied within applications (also referred to as computer programs), apps (small, generally single or narrow purposed applications), and/or methods, these aspects may also be embodied as computer-executable instructions stored by computer-readable media, also referred to as computer readable storage media, which (for purposes of this disclosure) are articles of manufacture. As those skilled in the art will recognize, computer readable media can host, store and/or reproduce computer-executable instructions and data for later retrieval and/or execution. When the computer-executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines and/or processes. Examples of computer-readable media include but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random-access memory (RAM), read-only memory (ROM), memory cards, thumb drives, and the like; cloud storage (i.e., an online storage service); and the like. While computer-readable media may reproduce and/or cause to deliver the computer-executable instructions and data to a computing device for execution by one or more processors via various transmission means and mediums, including carrier waves and/or propagated signals, for purposes of this disclosure computer-readable media expressly excludes carrier waves and/or propagated signals.

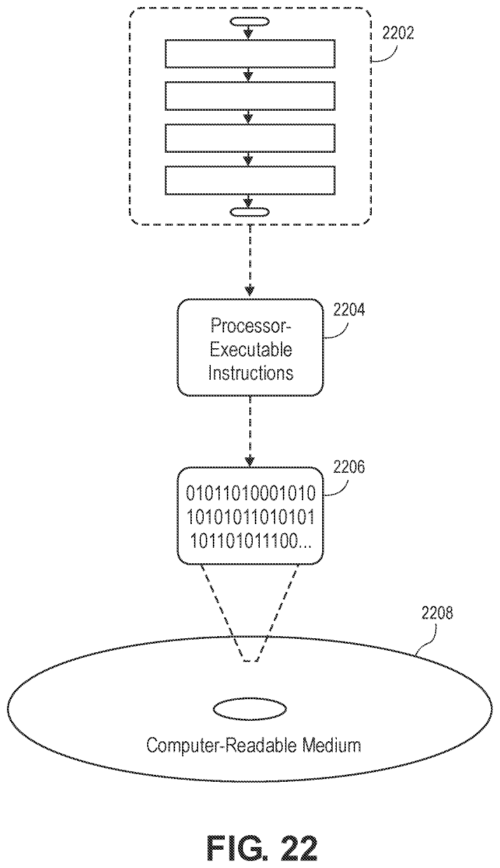

Regarding computer-readable media, FIG. 22 is a block diagram illustrating an exemplary computer-readable medium 2208 encoded with instructions for responding to a request for recommend content, formed in accordance with aspects of the disclosed subject matter. More particularly, the illustrated implementation comprises a computer-readable medium 2208 (e.g., a CD-R, DVD-R or a platter of a hard disk drive), on which is encoded computer-readable data 2206. This computer-readable data 2206 in turn comprises a set of processor-executable instructions 2204 configured to operate according to one or more of the principles set forth herein. In one such implementation 2202, the processor-executable instructions 2204 may be configured to perform a method, such as at least some of exemplary routines 500, 800, 900, 1600, 1800, 1900, 2000, 2050 and 2100, for example. In another such implementation, the processor-executable instructions 2204 may be configured to implement a system on a computing system or device, such as at least some of the exemplary, executable components of computer system 2300, as discussed in FIG. 23 below. Many such computer-readable media may be devised, by those of ordinary skill in the art, which are configured to operate in accordance with the techniques presented herein.

Turning to FIG. 23, FIG. 23 is a block diagram of a computer system suitably configured to implement aspects of a hosting service, especially regarding responding to a text-based request for content items, in accordance with aspects of the disclosed subject matter. The computer system 2300 typically includes one or more central processing units (or CPUs), such as CPU 2302, and further includes at least one memory 2304. The CPU 2302 and memory 2304, as well as other components of the computing system, are typically interconnected by way of a system bus 2310.

As will be appreciated by those skilled in the art, the memory 2304 typically (but not always) comprises both volatile memory 2306 and non-volatile memory 2308. Volatile memory 2306 retains or stores information so long as the memory is supplied with power. In contrast, non-volatile memory 2308 can store (or persist) information even when a power supply is not available. In general, RAM and CPU cache memory are examples of volatile memory 2306 whereas ROM, solid-state memory devices, memory storage devices, and/or memory cards are examples of non-volatile memory 2308.

As will be further appreciated by those skilled in the art, the CPU 2302 executes instructions retrieved from the memory 2304 from computer-readable media, such as computer-readable medium 2208 of FIG. 22, and/or other executable components, in carrying out the various functions of the disclosed subject matter. The CPU 2302 may be comprised of any of several available processors, such as single-processor, multi-processor, single-core units, and multi-core units, which are well known in the art.

Further still, the illustrated computer system 2300 typically also includes a network communication interface 2312 for interconnecting this computing system with other devices, computers and/or services over a computer network, such as network 108 of FIG. 1. The network communication interface 2312, sometimes referred to as a network interface card or NIC, communicates over a network using one or more communication protocols via a physical/tangible (e.g., wired, optical fiber, etc.) connection, a wireless connection such as WiFi or Bluetooth communication protocols, NFC, or a combination thereof. As will be readily appreciated by those skilled in the art, a network communication interface, such as network communication interface 2312, is typically comprised of hardware and/or firmware components (and may also include or comprise executable software components) that transmit and receive digital and/or analog signals over a transmission medium (i.e., the network 108).

The illustrated computer system 2300 also frequently, though not exclusively, includes a graphics processing unit (GPU) 2314. As those skilled in the art will appreciate, a GPU is a specialized processing circuit designed to rapidly manipulate and alter memory. Initially designed to accelerate the creation of images in a frame buffer for output to a display, due to their ability to manipulate and process large quantities of memory, GPUs are advantageously applied to training machine learning models and/or neural networks that manipulate large amounts of data, including LLMs and/or the generation of embedding vectors of text terms of an n-gram. One or more GPUs, such as GPU 2314, are often viewed as essential processing components of a computing system when conducting machine learning techniques. Also, and according to various implementations, while GPUs are often included in computing systems and available for processing or implementing machine learning models, multiple GPUs are also often deployed as online GPU services or farms and machine learning processing farms.

The illustrated computer system may also include an LLM 2330, a caption service 2331, and/or a caption data store 2336. As discussed herein, the captions service(s) 2331 may process content items and generate content item captions for each content item and/or generate a session item for a session of content items. Captions, such as content item captions and/or session captions may be stored in and/or accessed from the captions data store 2336. The LLM 2330 may process content item captions and/or session captions that are included in, or referenced by an LLM input and generate narrative descriptions of the sessions and/or indicate content item identifiers. Those narrative descriptions may be provided as a text-based request that is used to determine recommended content items, as discussed herein.

Also included in the illustrated computer system 2300 is a response module 2320. As operationally described above in regard to routine 1600 of FIG. 16, the response module 2320 is a logical, executable component of the computer system 2300 that, in execution, is configured to receive a text-based request for content items, generate a set of word pieces from the request, generate a representative embedding vector for the word pieces, identify a set of content items from a corpus of content items according to the representative embedding vector, and return at least some of the content items as a response of recommended content items. The identified content items may be determined according to a distance measure of the representative embedding vector, as projected in a content item embedding space, to content items of the corpus of content items projected into the content item embedding space. Additionally, the identified content items may be determined according to a random walk process of the content items represented in a content item graph.

In responding to a text-based request from a subscriber, the response module 2320 of the hosting service operating on the computer system 2300 utilizes term generator 2324 that conducts a lexical analysis of a received request and generates a set of text-based terms. The response module 2320 further utilizes a word pieces generator 2326 to generate a set of word pieces for the text-based terms of the request.

In identifying content items for the request, the response module 2320 utilizes a trained, executable embedding vector generator 2322 that generates, or obtains a request embedding vector for a set of word pieces of the text-based terms of a text-based request. As described in routine 1600 above, the response module 2320 utilizes a term generator 2324 that obtains a set of text-based terms from the received request, and further utilizes a word pieces generator 2326 to generate a set of word pieces from the set of text-based terms.

In addition to the above, the illustrated computer system 2300 also includes a training tuple generator 2328 that generates training tuples from request/content item logs 2340 (also referred to as request/user interaction logs) of the hosting service implemented on the computer system 2300.

Regarding the various components of the exemplary computer system 2300, those skilled in the art will appreciate that many of these components may be implemented as executable software modules stored in the memory of the computing device, as hardware modules and/or components (including SoCs-system on a chip), or a combination of the two. Indeed, components may be implemented according to various executable implementations including, but not limited to, executable software modules that carry out one or more logical elements of the processes described in this document, or as hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

For purposes of clarity and by way of definition, the term “exemplary,” as used in this document, should be interpreted as serving as an illustration or example of something, and it should not be interpreted as an ideal or leading illustration of that thing. Stylistically, when a word or term is followed by “(s),” the meaning should be interpreted as indicating the singular or the plural form of the word or term, depending on whether there is one instance of the term/item or whether there is one or multiple instances of the term/item. For example, the term “subscriber(s)” should be interpreted as one or more subscribers. Moreover, the use of the combination “and/or” with multiple items should be viewed as meaning either or both items.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method, comprising:
processing a first plurality of content items of a corpus of contents items to produce, for each content item of the first plurality of content items, a first content item caption that is descriptive of the content item;
processing a second plurality of content items that have been previously viewed by a user as part of a session to produce, for each content items of the second plurality of content items, a second content item caption that is descriptive of the content item;
determining, with a large language model and based at least in part on at least a portion of the first content item captions and at least a portion of the second content item captions, at least one content item of the first plurality of content items to present to the user; and
sending, for presentation to the user, the at least one content item.

2. The computer-implemented method of claim 1, further comprising:
determining a first sequence in which the second plurality of content items were viewed by the user;
determining, with the large language model and based at least in part on at least the portion of the first content item captions and at least the portion of the second content item captions, a third plurality of content items determined from the first plurality of content items to present to the user, wherein the third plurality of content items includes the at least one content item;
determining, with the large language model and based at least in part on the first sequence, a second sequence in which each content item of the third plurality of content items are to be presented to the user; and
sending, for presentation to the user, the third plurality of content items and an indication of the second sequence in which each content item of the third plurality of content items are to be presented to the user.

3. The computer-implemented method of claim 1, further comprising:
processing the first plurality of content items with an image encoder and language model to produce, for each content item of the first plurality of content items, the first content item caption that is descriptive of the content item; and
processing the second plurality of content items with the image encoder and language model to produce, for each content item of the second plurality of content items, the second content item caption that is descriptive of the content item.

4. The computer-implemented method of claim 1, further comprising:
determining, based at least in part on the second plurality of content items, the first plurality of content items, wherein the first plurality of content items is determined from the corpus of content items that includes the first plurality of content items and the second plurality of content items; and
wherein the first plurality of content items does not include the second plurality of content items.

5. A computer-implemented method, comprising:
processing a plurality of content items of a session to produce a caption;
determining, for the plurality of content items, contextual metadata corresponding to the plurality of content items;
providing, as part of a large language model (“LLM”) input to an LLM, the caption and at least a portion of the contextual metadata;
receiving from the LLM and in response to the LLM input, an LLM output; and
determining, based at least in part on the LLM output, at least one content item from a corpus of content items as representative of the plurality of content items, wherein the at least one content item is not included in the plurality of content items.

6. The computer-implemented method of claim 5, further comprising:
determining a first sequence of presentation corresponding to the plurality of content items;
determining, based at least in part on the LLM output, a second plurality of content items from the corpus, wherein the second plurality of content items includes the at least one content item;
determining, based at least in part on the first sequence, a second sequence of presentation for the second plurality of content items; and
causing a presentation of the second plurality of content items according to the second sequence.

7. The computer-implemented method of claim 5, further comprising:
determining, based at least in part on the plurality of content items, a second plurality of content items that do not include the plurality of content items;
processing the second plurality of content items to produce, for each content item of the second plurality of content items, a second content item caption; and
including, as part of the LLM input, the second content item caption for each of the second plurality of content items; and
wherein the at least one content item is included in the second plurality of content items.

8. The computer-implemented method of claim 7,
wherein processing the plurality of content items includes processing the plurality of content items to produce, for each content item of the plurality of content items, a content item caption that is descriptive of the content item; and
the method further comprising:
including, as part of the LLM input, the second content item caption for each of the second plurality of content items.

9. The computer-implemented method of claim 8, wherein:
each second content item caption for each content item of the second plurality of content items that is included in the LLM input further includes a second content item identifier corresponding to the content item; and
wherein the LLM output includes a content item identifier that is used to determine the at least one content item.

10. The computer-implemented method of claim 5, wherein:
the LLM output includes a narrative description of the plurality of content items; and
determining the at least one content item, further includes:
processing the narrative description to determine the at least one content item.

11. The computer-implemented method of claim 10, wherein processing the narrative description includes:
converting the narrative description into an embedding;
projecting the embedding into a multi-dimensional space that includes a plurality of embeddings corresponding to content items of the corpus of content items; and
determining, based at least in part on the projection and the plurality of embeddings, the at least one content item.

12. The computer-implemented method of claim 5, wherein the at least one caption is a session caption that is descriptive of the plurality of content items of the session.

13. The computer-implemented method of claim 5, wherein the LLM output further includes an indication of a taste preference represented in the plurality of content items.

14. The computer-implemented method of claim 5, wherein the LLM input is defined to include at least:
the caption;
an instruction to be followed by the LLM in processing the LLM input; and
a response structure indicating a structure in which the LLM output is to be provided.

15. A computer-implemented method, comprising:
processing a plurality of content items of a session to produce, for the session, a session caption that is descriptive of the plurality of content items;
providing, as part of a large language model (“LLM”) input to an LLM, the session caption;
receiving from the LLM and in response to the LLM input, a narrative description of the session; and
determining, based at least in part on the narrative description, at least one content item from a corpus of content items as representative of the plurality of content items, wherein the at least one content item is not included in the plurality of content items.

16. The computer-implemented method of claim 15, wherein processing the plurality of content items further includes:
processing the plurality of content items with a first caption service to generate a first service caption that is descriptive of the plurality of content items as determined by the first caption service;
processing the plurality of content items with a second caption service to generate a second service caption that is descriptive of the plurality of content items as determined by the second caption service, wherein the first caption service and the second caption service are different; and
combining at least the first service caption and the second service caption to produce the session caption.

17. The computer-implemented method of claim 15, wherein determining the at least one content item further includes:
processing the narrative description as a text-based request to a query service to determine the at least one content item.

18. The computer-implemented method of claim 15, wherein each of the plurality of content items include a visual representation of one or more physical objects.

19. The computer-implemented method of claim 15, further comprising:
determining a merchant that offers for sale an object represented in the at least one content item; and
sending, for presentation, the at least one content item and an indication of the merchant.

20. The computer-implemented method of claim 15, further comprising:
receiving, from a user, a selection of the plurality of content items as part of the session in which the user is viewing content items from the corpus of content items.
